(19) United States
(12) Patent Application Publication
(10) Pub. No.: US 2009/0007210 A1
(43) Pub. Date: Jan. 1, 2009

(54) Apparatus, method, and program for CATV transmission-path monitoring

(75) Inventors: Makoto Nishide, Ise (JP); Eiji Miyazoe, Kawasaki (JP); Shigeki Hosaka, Kawasaki (JP)

Correspondence Address: WENDEROTH, LIND & PONACK, L.L.P., 2033 K STREET N. W., SUITE 800, WASHINGTON, DC, 20006-1021, US

(73) Assignee: OSS BROADNET CO., LTD.

(21) Appl. No.: 12/081,920

(22) Filed: Apr. 23, 2008

(30) Foreign Application Priority Data
Jun. 29, 2007 (JP) 2007-171600

(51) Int. Cl. H04N 7/173

(52) U.S. Cl. 725/125

(57) ABSTRACT

Gate switches can switch an amount of attenuation, and are set in a distributed manner on distribution lines and a trunk on subscribers' house side in a CATV transmission path having a tree structure with an optical node that follows a headend being taken as a starting point. An upstream-transmission-quality monitoring unit monitors an S/N ratio of an upstream signal obtained from an upstream port having the headend connected thereto to detect a decrease in upstream transmission quality based on a degree of decrease and a continuation state of an S/N ratio. When the upstream-transmission-quality monitoring unit detects a decrease in upstream transmission quality, a noise-generation-source searching unit performs a sequential switching control over the amount of attenuation at the gate switches provided on the CATV transmission path from upstream to downstream to search for a source of generation of upstream ingress noise.

This application is a priority based on prior application No. JP 2007-171600, filed Jun. 29, 2007, in Japan.

### BACKGROUND OF THE INVENTION

1. Field of the Invention

The present invention relates to ingress-noise monitoring systems and methods of detecting a decrease in upstream transmission quality due to an upstream ingress noise in a CATV system to search for a noise generation source and, in particular, an ingress-nose monitoring system and method of automatically searching for a generation source of the upstream ingress noise through control of insertion and separation of an attenuator through gate switches disposed on trunk and branch lines of a CATV transmission path.

2. Description of the Related Arts

Conventionally, there has been a problem that, in a CATV transmission path having a tree-like structure, when noise occurring at a subscriber's home on an upstream side is mixed into an upstream transmission path, the noise is propagated from an upstream side to a downstream side to become ingress noise, thereby decreasing signal quality on a service channel assigned to an upstream transmission band of 5 to 42 Mz. Thus, conventionally, to monitor such ingress noise that decreases upstream transmission quality, a spectrum analyzer is connected to an upstream port, such as a data modem, disposed at the headend to cause the spectrum distribution of an upstream signal band to be displayed on a screen, and a person for monitoring the transmission path manually uses a gate switch controller connected to the headend side to perform a switching operation from upstream to downstream on on/off-type gate switches disposed on trunk and branch lines of the CATV transmission path while watching the spectrum screen, thereby dividing the transmission path where an ingress-noise generation source is present to track down a generation source, such as a collective housing. However, such artificial detection of the upstream ingress noise and division for a generation source take time and effort. To get around such problems, the upstream-ingress-noise detection system has been suggested, in which a gate switch is specified as a noise mixing source by automatically switching gate switches (JP 2004-72477).

However, such a conventional upstream ingress-noise detection system has the following problems. First, in the conventional upstream ingress-noise detection system, noise of an upstream signal is quantitatively measured at the headend side to determine the presence or absence of ingress noise. For this upstream-signal noise measurement, a spectrum analyzer or a Fourier-transformation analyzer (FFT analyzer) is used. However, the necessity of such a special measurement device increases cost and also causes complicated maintenance. Moreover, in monitoring of the upstream ingress-noise using a spectrum analyzer or a Fourier-transformation analyzer (FFT analyzer), for a spectrum of an upstream signal band, different thresholds are separately set for an actually-used signal band and an unused signal band to determine the presence or absence of ingress noise, thereby requiring the complicated setting of optimum thresholds. Furthermore, in the conventional upstream ingress-noise detection system, no consideration is given to temporal fluctuations in the upstream ingress noise. Therefore, when the upstream signal exceeds a threshold, it is immediately determined that ingress noise is present. Thus, even non-continuous the upstream ingress noise that appears and then disappears for a short time is detected in order to search for a noise generation source, thereby causing a problem of unnecessarily increasing the process load. Still further, in the conventional upstream ingress-noise detection system, for division for the upstream ingress-noise generation source, on/off-type gate switches capable of controlling passage and interruption of the upstream band are used. Therefore, when a gate switch is controlled to be in an interrupted state for division for an ingress-noise generation source, the upstream signal from a device connected to the downstream side is also interrupted. Thus, for example, when cable modems are set in each of the trunk and branch lines and subscribers' homes and measurement values are collected by polling the cable modems to monitor faults in a CATV system, the upstream signal whose measurement value is returned from the data modem does not respond due to an interruption control over the gate switches, thereby impairing the monitoring function of the CATV system. Still further, in recent years, services included in lifelines have increased, such as a primary IP telephone service in CATV systems. However, there is the problem that when an interruption control is performed over gate switches for division for the upstream ingress noise, services such as the primary IP telephone service stops.

### SUMMARY OF THE INVENTION

According to the present invention to provide upstream ingress-noise monitoring system and method capable of more appropriately detecting a decrease in upstream transmission quality due to upstream ingress noise based on a degree of decrease and a continuation state of an S/N ratio of an upstream port having a headend connected thereto and automatically searching for a noise generation source through a switching control over gate switches without interrupting an upstream signal is provided.

(System)

The present invention provides the upstream-ingress-noise monitoring system. The upstream-ingress-noise monitoring system according to the present invention includes:

a CATV transmission path having a tree structure with an optical node following a headend being taken as a starting point;

a plurality of gate switches placed in a distributed manner on branch lines and a trunk on a subscribers' home side on the CATV transmission path, the gate switches capable of switching an amount of attenuation of an upstream signal;

an upstream-transmission-quality monitoring unit that monitors an S/N ratio of the upstream signal in a use band obtained from an upstream port having the headend connected thereto to detect a decrease in upstream transmission quality based on a degree of decrease and a continuation state of the S/N ratio; and

a noise-generation-source searching unit that searches for an upstream-ingress-noise generation source by sequentially controlling from upstream to downstream the amount of attenuation of the gate switches provided on the CATV transmission path when a decrease in upstream transmission quality is detected by the upstream-transmission-quality monitoring unit.

Here, the upstream-transmission-quality monitoring unit holds, for a predetermined decision time, S/N ratios detected at each predetermined cycles from the upstream signal in the use band obtained from the upstream port, calculates a ratio of the number of detected SIN ratios equal to or smaller than a predetermined S/N threshold with respect to a total number of the detected S/N ratios for the decision time and, when the calculated ratio exceeds a predetermined threshold ratio, detects a decrease in upstream transmission quality.

The transmission-quality monitoring unit sets a first threshold ratio for alarm notification and a second threshold ratio higher than the first threshold ratio for searching for a noise generation source, each as the threshold ratio, and

when the calculated ratio exceeds the first threshold ratio, provides a notification of an alarm indicative of a decrease in upstream transmission quality, and when the calculated ratio exceeds the second threshold ratio, detects a decrease in upstream transmission quality and causes the noise-generation-source searching unit to operate.

The noise-generation-source searching unit

makes an instruction for an attenuator-on control of inserting and connecting an attenuator into an upstream transmission path and, after a predetermined measurement time has elapsed, makes an instruction for an attenuator-off control of removing the attenuator from the upstream transmission path, over a gate switch as a control target, and

when an increase is found in the S/N ratio obtained after the attenuator-on control compared with the S/N ratio before the attenuator-on control and when the S/N ratio obtained after the attenuator-off control is back to the S/N ratio before the attenuator-on control, determines that an upstream-ingress-noise generation source is present under the gate switch as the control target.

When making an instruction for the attenuator-on control or the attenuator-off control over the gate switch as the control target, after checking a control operation of the gate switch, the noise-generation-source searching unit obtains the S/N ratio of the upstream signal in the use band obtained from the upstream port for determination.

The noise-generation-source searching unit according to the present invention uses cable modems to check the operation of the gate switches. For this purpose, the ingress-noise monitoring system according to the present invention further includes:

a plurality of cable modems placed in a distributed manner on the branch lines and the trunk on the subscribers' home side placed in the CATV transmission path;

an information collecting unit that collects measurement values detected at the plurality of cable modems through polling; and

a cable router that instructs a cable modem of a transmission source to control an upstream transmission level so that a reception level of the upstream signal received with the polling by the information collecting unit is kept at a constant value, wherein

the noise-generation-source searching unit

obtains an upstream transmission level of the cable modem positioned downstream of the gate switch,

makes an instruction for the attenuator-on control and, after a predetermined measurement time has elapsed, makes an instruction for the attenuator-off control over the gate switch as the control target, and

when there is a fluctuation in upstream transmission level equal to or larger than a predetermined value before and after the attenuator-on control and the attenuator-off control, determines that an operation of the gate switch has been completed.

Also, the noise-generation-source searching unit according to the present invention may check the operation using a response function of the gate switches. That is, when making an instruction for the attenuator-on control or the attenuator-off control over the gate switch as the control target, after receiving an operation-complete response signal from the gate switch, the noise-generation-source searching unit obtains the S/N ratio of the upstream signal in the use band obtained from the upstream port for determination.

The noise-generation-source searching unit manages addresses of the plurality of gate switches with the number of hops as an identifier counted up every time passing through an active device toward downstream side, with the optical node on the CATV transmission path being taken as a starting point, and controls the plurality of gate switches according to an order of the number of hops to search for an ingress-noise generation source.

In the ingress-noise monitoring system according to the present invention,

a plurality of cable modems placed in a distributed manner on the branch lines and the trunk on the subscribers' home side placed in the CATV transmission path;

an information collecting unit that collects measurement values detected at the plurality of cable modems through polling;

a cable router that instructs a cable modem of a transmission source to control an upstream transmission level so that a reception level of the upstream signal received with the polling by the information collecting unit is kept at a constant value; and

a transmission-path-map generating unit that sequentially controls all of the gate switches placed at each output port of a plurality of transmission-path devices on the CATV transmission path to change the amount of attenuation of the upstream signal and detects a cable modem in which a reception level of the upstream signal has been changed with a change in the amount of attenuation to generate a transmission-path map of the transmission-path devices, are provided, and the noise-generation-source searching unit searches for an upstream-ingress-noise generation source based on the transmission-path map.

The transmission-path map generating unit includes:

a correspondence-list generating unit that generates a registered correspondence list in which a correspondence relation among one or a plurality of cable modems in which the transmission level of the upstream signal has been changed due to the control over all of the gate switches disposed on the CATV transmission path; and

a parent-child-relation determining unit that determines a parent-child relation of all of the gate switches from the correspondence list to generate a transmission-path map.

The parent-child-relation determining unit calculates and registers the number of modems of the cable modems registered for each of the gate switches for the correspondence list and then performs sorting in an order of the number of modems,

generates a gate switch arrangement list having stored therein gate-switch arrangements in which the gate switches are arranged in the order of the number of hops for each cable modem based on the sorted correspondence list,

sequentially takes out a plurality of gate switch arrangements stored in the gate switch arrangement list each as a process target and, when another gate switch arrangement that includes the gate switch arrangement as the process target and has a same or more number of hops is present, deletes the gate switch arrangement as the process target from a parent-child-relation decision target,

merges the same gate switches included in one or a plurality of gate switch arrangements left in the gate switch arrangement list for conversion to a gate-switch transmission-path map having a tree structure, and

adds the transmission-path devices and the cable modems to the gate-switch transmission-path map to complete the transmission-path map.

(Method)

The present invention provides an upstream ingress-noise monitoring method. The present invention relates to an ingress-noise monitoring method of a CATV system including

a CATV transmission path having a tree structure with an optical node following a headend being taken as a starting point and

a plurality of gate switches placed in a distributed manner on branch lines and a trunk on a subscribers' home side on the CATV transmission path, the gate switches capable of switching an amount of attenuation of an upstream signal, the method including:

an upstream-quality monitoring step of monitoring an S/N ratio of the upstream signal (service channel signal) in a use band obtained from an upstream port having the headend connected thereto to detect a decrease in upstream transmission quality based on a degree of decrease and a continuation state of the S/N ratio; and

a noise-source searching step of searching for an upstream-ingress-noise generation source by sequentially controlling from upstream to downstream the amount of attenuation of the gate switches provided on the CATV transmission path when a decrease in upstream transmission quality is detected in the upstream-quality monitoring step.

According to the present invention, a decrease in upstream transmission quality due to upstream ingress noise is detected from a degree of decrease and a continuous state of an S/N ratio of an upstream signal (service channel signal) in use in an upstream port on a data processing side connected to a headend, thereby detecting upstream ingress noise without using expensive equipment, such as a spectrum analyzer.

Also, an in-band monitoring system is used that monitors the S/N ratio of the upstream signal in a service channel actually used in the CATV system. Therefore, compared with a case where frequency bands including even an unused frequency band are collectively monitored by a spectrum analyzer in an upstream all-band monitoring system, an actual decrease in communication service at a subscriber's home and a decrease in upstream transmission quality based on the SIN ratio through monitoring accurately coincide each other, thereby appropriately handling the occurrence of upstream ingress noise.

Furthermore, S/N ratios measured at predetermined cycles are held for a predetermined period, and a ratio of SIN ratios equal to or smaller than a predetermined S/N threshold with respect to the entirety is calculated. If this ratio exceeds a predetermined threshold ratio, a decrease in upstream transmission quality is detected. This prevents ingress noise that appears and then disappears for a short time from being unnecessarily detected to automatically search for a generation source, thereby allowing stable monitoring of upstream ingress noise.

Still further, a control over gate switches for detecting a decrease in upstream transmission quality to search for a noise generation source is a switching control of inserting or separating an attenuator in and from upstream band. With insertion and separation of the attenuator, the upstream signal is attenuated to be returned to the original, thereby monitoring changes in S/N ratio. If the S/N ratio is increased to be returned to the original, it is determined that a noise generation source is present on the downstream side of the gate switch. With such a switching control of insertion and separation of the attenuator with gate switches, the upstream signal from downstream is attenuated but is not interrupted. Even during a control over the gate switches, the upstream signal on a service channel can be continuously received at a headend side.

For example, when cable modems are set on the trunk and branch lines and at subscribers' homes on the CATV transmission path and measurement values are provided through polling for response with upstream signals to monitor a system fault, even if the gate switches are controlled for searching for an upstream-ingress-noise generation source, it is possible to quickly and appropriately track down a noise generation source without impairing a system monitoring function.

Still further, when an attenuator-on or-off control instruction is sent to a gate switch, a response of process normally end is waited from the gate switch, switching is confirmed, and then an S/N ratio of the upstream port is obtained for determination. With this, it is possible to reliably prevent an erroneous determination with the gate switch not yet switched due to an erroneous operation.

Still further, when a response of process normally end cannot be obtained from any gate switch or when each gate switch does not have a response function, by using a feedback control of keeping an upstream transmission level at a defined level with respect to fluctuations in an upstream signal level of the cable modem for fault monitoring provided to each of the trunk and branch lines and subscribers' homes on the CATV transmission path, the process normal end of the gate switch is determined.

That is, in fault monitoring by using cable modems, predetermined measurement values are collected through polling responses from the cable modems. At this time, a cable router instructs a cable modem of a transmission source to control the upstream transmission level so as to keep a received upstream signal level in association with polling by an information collecting unit at a constant value.

Therefore, when an attenuator on-control or an attenuator off-control is performed over a gate switch for searching for an upstream-ingress-noise generation source, a reception level is fluctuated due to a polling response from a data modem on a downstream side. For this, the upstream transmission level of the cable modem of the transmission source is fluctuated so as to keep the reception level at the defined value.

Thus, if the upstream transmission level of the cable modem on the downstream side is fluctuated by a value equal to or larger than a predetermined value before and after gate switch control, it can be determined that the gate switch has been normally switched. With this, the process normal end of the gate switch can be determined.

Still further, in the present invention, a control function of the cable router is used, in which, in order to make the reception level of the upstream signal from the cable modem positioned on the downstream side at a constant value, the transmission level of the upstream signal of the cable modem is controlled based on fluctuations in the amount of attenuation through an attenuator control for gate switches. All gate switches provided on the CATV transmission path are controlled to detect a cable modem in which its upstream signal transmission level has been changed. From the detection result, a parent-child relation among the gate switches is determined. Even for an unknown CATV transmission path, a transmission-path map is automatically generated, which can be used for searching for an upstream-ingress-noise generation source. The above and other objects, features, and advantages of the present invention will become more apparent from the following detailed description with reference to the drawings.

### BRIEF DESCRIPTION OF THE DRAWINGS

FIGS. 1A and 1B are block diagrams depicting an embodiment of an upstream-ingress-noise monitoring system according to the present invention;

FIG. 2 is a circuit block diagram depicting a gate switch for use in the present embodiment;

FIG. 3 is a descriptive drawing that depicts a determination of decrease in upstream transmission quality based on an S/N ratio obtained from an upstream port;

FIGS. 4A and 4B are descriptive drawings that depict a CATV transmission path to be monitored by the present invention;

FIG. 5 is a descriptive drawing that depicts a gate switch management table for use in searching for a generation source of upstream ingress noise in the present embodiment;

FIG. 6 is a flowchart depicting a process of monitoring upstream transmission quality in the present embodiment;

FIGS. 7A and 7B are flowcharts depicting details of a process of searching for an upstream-ingress-noise generation source in step S7 of FIG. 6;

FIGS. 8A and 8B are flowcharts depicting a gate-switch control process with a cable-modem operation check in the present embodiment;

FIG. 9 is a flowchart depicting a cable-modem polling process in the present embodiment;

FIGS. 10A and 10B are flowcharts depicting a gate-switch control process according to another embodiment in the present invention;

FIGS. 11A and 11B are descriptive drawings that depicts one example of a CATV transmission path for which a transmission-path map is generated according to the present embodiment;

FIG. 12 is a descriptive drawing that depicts transmission device information for use in generating a transmission-path map according to the present embodiment;

FIG. 13 is a descriptive drawing that depicts cable-modem information for use in generating a transmission-path map according to the present embodiment;

FIG. 14 is a descriptive drawing that depicts a correspondence list generated through attenuator-on/off control of gate switches in a transmission-path-map generating process according to the present embodiment;

FIG. 15 is a descriptive drawing that depicts a correspondence list generated by randomly arranging gate switches and cable modems;

FIG. 16 is a descriptive drawing that depicts a gate switch arrangement list for each cable modem number generated from the correspondence list of FIG. 14;

FIG. 17 is a descriptive drawing that depicts a gate-switch transmission-path map in which gate switch arrangements left as determination targets in the process of FIG. 16 are disposed;

FIG. 18 is a descriptive drawing that depicts gate-switch merge processes in the gate-switch transmission-path map of FIG. 17;

FIG. 19 is a descriptive drawing that depicts a gate-switch transmission-path map generated through the merge process of FIG. 18;

FIG. 20 is a descriptive drawing that depicts a modified portion in the CATV transmission path of FIGS. 11A and 11B;

FIGS. 21A and 21B are descriptive drawings of a correspondence list generated through an attenuator on/off control of gate switches targeted for the CATV transmission path of FIGS. 11A and 11B including the modification of FIG. 19; and

FIGS. 22A and 22B are flowcharts depicting a transmission-path-map generation process according to the present embodiment

### DETAILED DESCRIPTION OF THE PREFERRED EMBODIMENTS

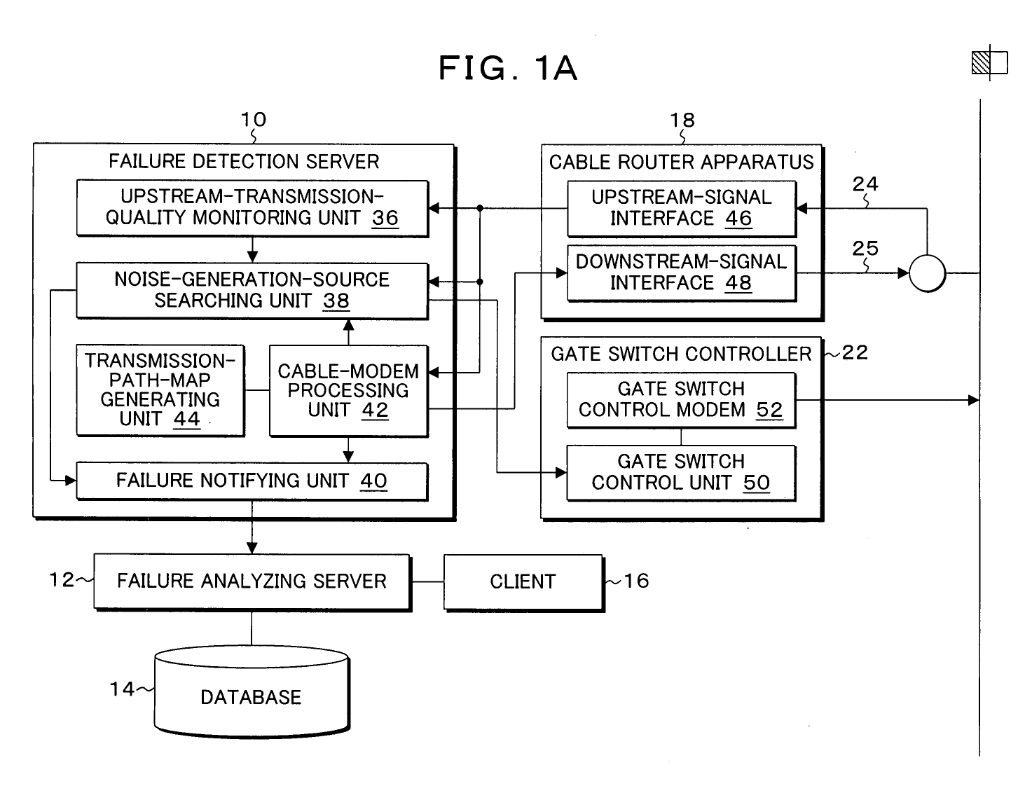

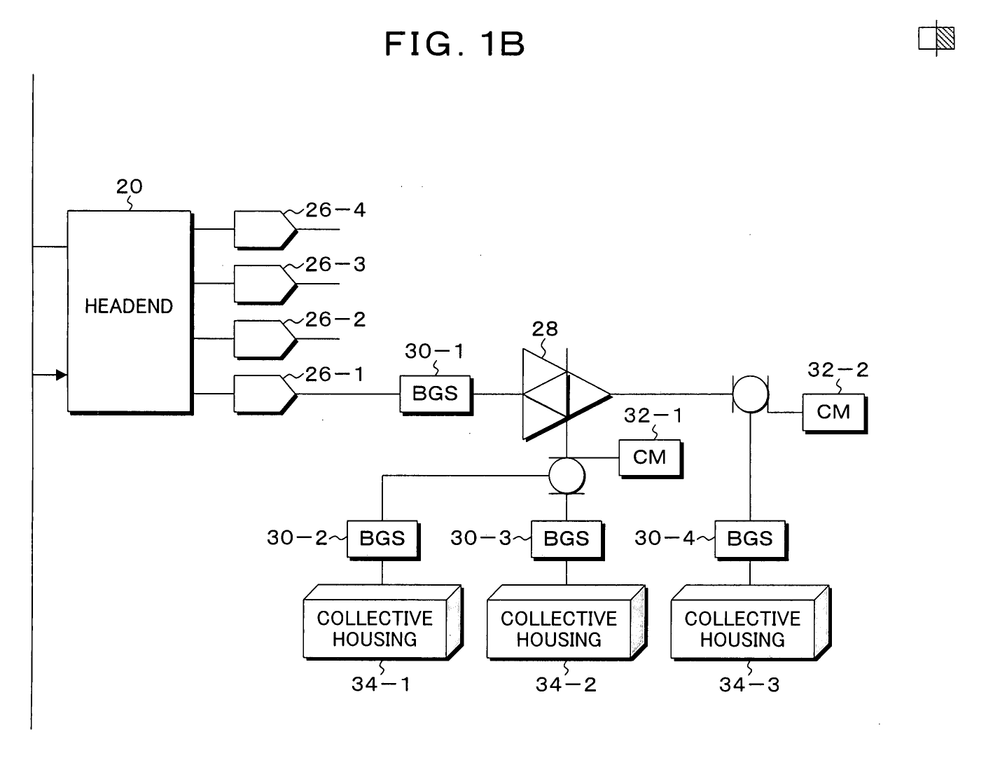

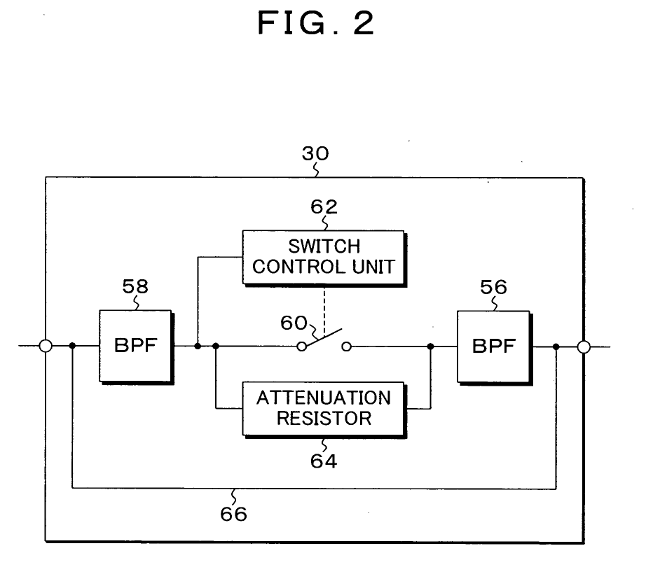

FIGS. 1A and 1B are block diagrams depicting an embodiment of an upstream-ingress-noise monitoring system according to the present invention. In FIGS. 1A and 1B, following a headend 20, optical nodes 26-1 to 26-4 are provided. Representing, this is depicted in the optical node 26-1, a CATV transmission path having a tree structure starting from that optical node is provided from upstream to downstream. In this example, following the optical node 26-1, via a bridger gate switch (hereinafter simply referred to as a “gate switch”) 30-1, a trunk branch amplifier (TBA) 28 of a bidirectional amplification type is provided, and is respectively connected to collective housings 34-1 to 34-3 via branch-terminal gate switches 30-2 to 30-4 of the trunk branch amplifier 28. Also, branch lines of the trunk branch amplifier 28 have cable modems 32-1 and 32-2 respectively connected thereto. To the headend 20, a fault detection server 10 is connected via a cable router apparatus 18. To the fault detection server 10, a fault analyzing server 12 is connected including a database 14. Further to the fault analyzing server 12, a client 16 is connected. The fault detection server 10 is provided with an upstream-transmission-quality monitoring unit 36, a noise-generation-source searching unit 38, a fault notifying unit 40, and, furthermore, a transmission-path-map generating unit 44 as required for the upstream ingress-noise monitoring. Still further, a cable-modem processing unit 42 is provided for monitoring a fault by using the cable modems 32-1 and 32-2 connected to the CATV transmission path. The cable router apparatus 18 has an interface function for data communication with the CATV transmission path on the headend 20 side. In the present embodiment, an interface function complying with DOCSIS (Data-Over-Cable Service Interface Specifications) is achieved. For this purpose, the cable router apparatus 18 is provided with an upstream-signal interface 46 and a downstream-signal interface 48. The upstream-signal interface 46 demodulates an upstream signal from the CATV transmission path for data communication, the demodulation for a channel band of a predetermined service channel assigned in an upstream frequency band of 5 to 42 MHz. The downstream-signal interface 48 provided in the cable router apparatus 18 modulates and transmits a data signal to the CATV transmission path in a frequency band of a downstream signal. To this upstream-signal interface 46 of the cable router apparatus 18, an upstream port 24 is connected from the headend 20. From the downstream-signal interface 48, a downstream port 25 is connected. For the headend 20, which is provided with a BGS controller 22 for controlling the gate switches 30-1 to 30-4 provided on the CATV transmission path. The BGS controller 22 includes a BGS control unit 50 and a BGS control modem 52. The BGS control unit 50 performs control over a specified gate switch based on an instruction from the noise-generation-source searching unit 38 provided to the fault detection server 10. The BGS control modem 52 transmits a command signal and receives response data among the gate switches 30-1 to 30-4 according to an SNMP protocol. Here, as for the gate switches 30-1 to 30-4 provided on the CATV transmission path, representing, this is depicted in the gate switch 30 of FIG. 2, a switch 60 subjected to an on/off control by a switch control unit 62 is connected between band-pass filters that lets a signal pass through an upstream signal band, an attenuation resistor 64 is connected in parallel with the switch 60, and further a bypass circuit 66 that bypasses the band-pass filters 56 and 58 is provided. Upon receiving an attenuator-on control command from the BGS controller 22 of FIGS. 1A and 1B, the switch control unit 62 causes the switch 60 to be turned off and causes an attenuation resistor to be inserted and connected into an upstream transmission path connecting between the band-pass filters 56 and 58, thereby providing a predetermined attenuation to the upstream signal. Also, when an attenuator-off control command is received from the BGS controller 22, the switch 60 is turned on, and a control of separating the attenuation resistor inserted and connected into the upstream transmission path is performed. Also, the gate switch 30 is of either one of two types as for a switch operation for a control command from the BGS controller 22, that is, a type of response-transmitting an operation-complete response and a type of not transmitting an operation-complete response. In the present embodiment, either type can be supported. Furthermore, the gate switch 30 may be, other than a single device, one in which a gate switch is integrally incorporated for each terminal of an active device, such as the trunk branch amplifier 28 of FIGS. 1A and 1B. The present embodiment includes both types. Referring again to FIGS. 1A and 1B, the upstream-transmission-quality monitoring unit 36 provided to the fault detection server 10 for monitoring upstream ingress noise according to the present embodiment monitors an S/N ratio of an upstream signal in a use band corresponding to a service channel obtained from the upstream port 24 that connects the headend 20 to the cable router apparatus 18 and, based on a degree of decrease and a continuous state of the S/N ratio being monitored, detects a decrease in upstream transmission quality due to upstream ingress noise. In this detection of a decrease in upstream transmission quality by the upstream-transmission-quality monitoring unit 36, the SIN ratios detected from the upstream signal in the use band obtained from the upstream port 24 at predetermined cycles T1, for example, T1=1 second, are held for a predetermined decision time T2, for example, T2=20 seconds. A ratio of a number B of the detected S/N ratios equal to or smaller than the predetermined S/N threshold with respect to a total number A of the detected S/N ratios obtained over the decision time T2 (B/A) is then calculated. When this calculated ratio (B/A) exceeds a predetermined threshold ratio C, a decrease in upstream transmission quality is detected.

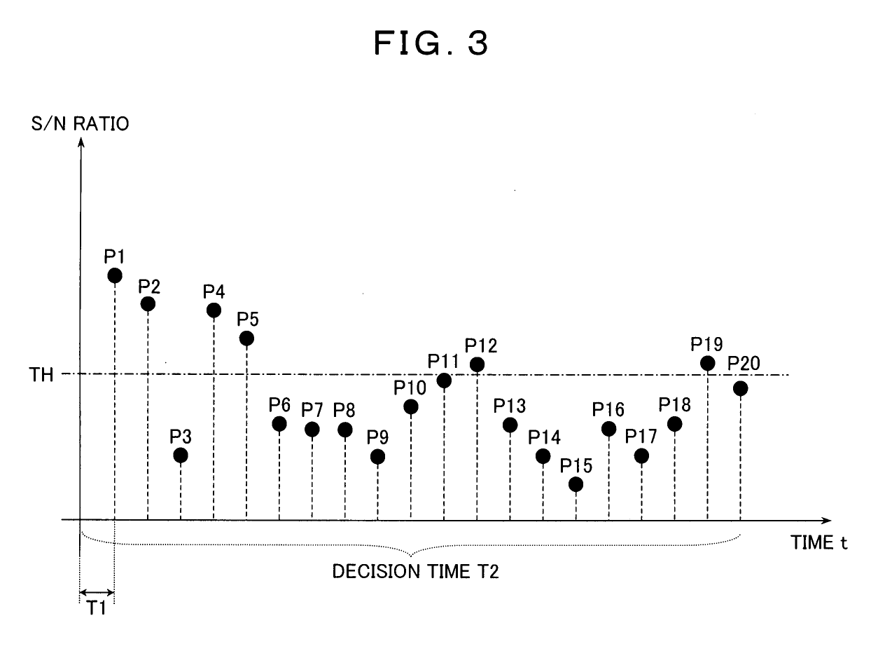

FIG. 3 is a descriptive drawing that depicts a specific example of detection of a decrease in upstream transmission quality by the upstream-transmission-quality monitoring unit 36 of FIGS. 1A and 1B. FIG. 3 depicts S/N ratios of the upstream signal in the use band found at the cycles T1 from the upstream port 24 over the decision time T2 with respect to a time axis. During the decision time T2, twenty S/N ratios presented by P1 to P20 are obtained. For P1 to P20, which are twenty S/N ratios obtained in this decision time T2, the predetermined S/N threshold TH is set. When it is assumed that a total number of S/N ratios in the decision time T2 is taken as A, A=20 in this case. For the S/N rations of P1 to P20, the number B of the S/N ratios equal to or smaller than the threshold TH is found. In this case, the number B of the S/N ratios equal to or smaller than the threshold TH is such that B=14. As a ratio of the total number A of S/N ratios=20 and the number B of S/N ratios equal to or smaller than the threshold TH=14, (B/A)=(14/20)=0.7 is calculated. To this calculated ratio (B/A), the predetermined threshold ratio C is set in advance for determining upstream transmission quality, for example, C=0.7. In this case, since the ratio (B/A)=0.7 is equal to or larger than the threshold ratio C=0.7, a decrease in upstream transmission quality will be detected. In the present embodiment, as the threshold ratios for the S/N ratio (B/A), a first threshold ratio C1 for alarm notification and a second threshold ratio C2 higher than that for searching for a noise generation source are set. For example, the first threshold ratio C1 for alarm notification is such that C1=0.6, whilst the second threshold ratio C2 for searching for a noise generation source C2 is such that C2=0.7. In this manner, with the threshold ratios being set in two steps, when the ratio of the number of S/N rations equal to or smaller than the threshold TH with respect to the total number of S/N ratios (B/A) exceeds the first threshold ratio C1=0.6, a notification of an alarm indicating a decrease in upstream transmission quality is first provided, thereby urging an administrator of the CATV equipment to use caution. Then, when the calculate ratio (B/A) becomes equal to or larger than the second threshold ratio C2=0.7 for searching for a noise generation source, the noise-generation-source searching unit 38 depicted in the fault detection server 10 of FIGS. 1A and 1B is operated. The noise-generation-source searching unit 38 provided in the fault detection server 10 of FIGS. 1A and 1B sequentially controls from upstream to downstream the amount of attenuation with respect to the upstream signal in the use band of the gate switches 30-1 to 30-4 provided on the CATV transmission path when a decrease in upstream transmission quality is detected at the upstream-transmission-quality monitoring unit 36, and then searches for an upstream-ingress-noise generation source. In searching for an upstream-ingress-noise generation source through a control over the gate switches, the gate switches are sequentially selected as a control target from upstream to downstream with an optical node being taken as a starting point. To each gate switch selected as a control target, an attenuator-on control command is transmitted to insert and connect an attenuator (attenuation resistor) in the upstream transmission path to attenuate the upstream signal. With this, when the S/N ratio of the headend 20 is increased, it is determined that a noise generation source is present on a downstream side of that gate switch. On the other hand, if the S/N ratio of the upstream port 24 is not fluctuated even when the attenuator (attenuation resistor) is inserted and connected to the upstream transmission path to attenuate the upstream signal, it is determined that a noise generation source is not present on a downstream side, and switching is made to a control over the next gate switch on the downstream side for which the S/N ratio is increased and it is determined that a signal generation source is present. This control is sequentially performed toward the downstream side, thereby searching for an upstream-ingress-noise generation source.

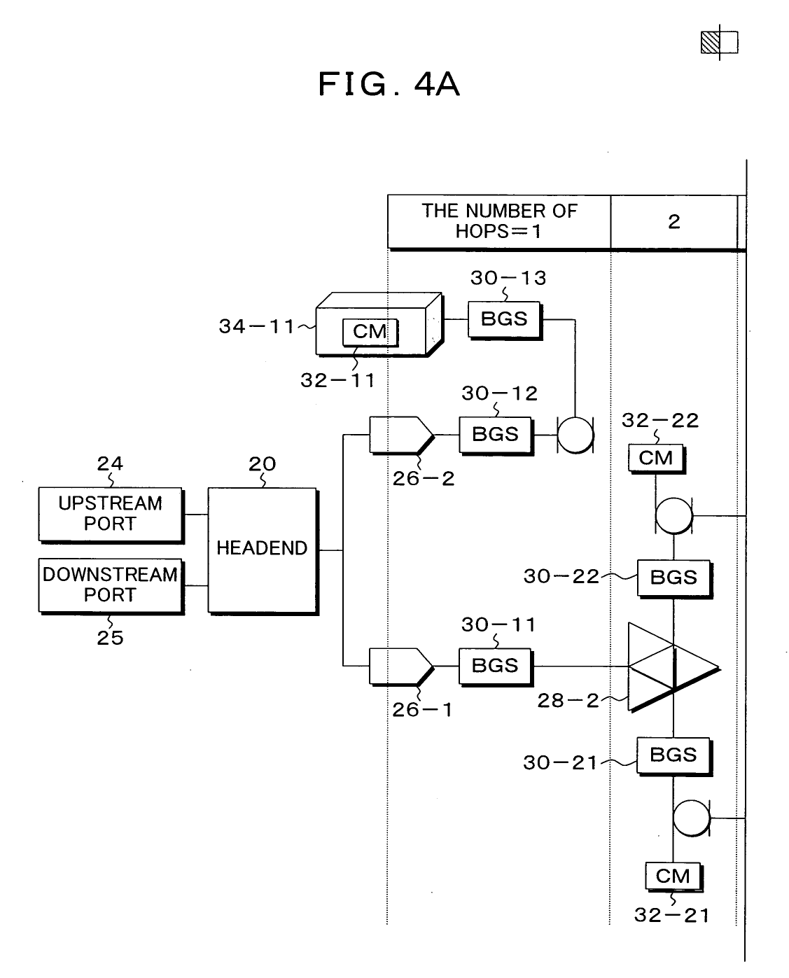

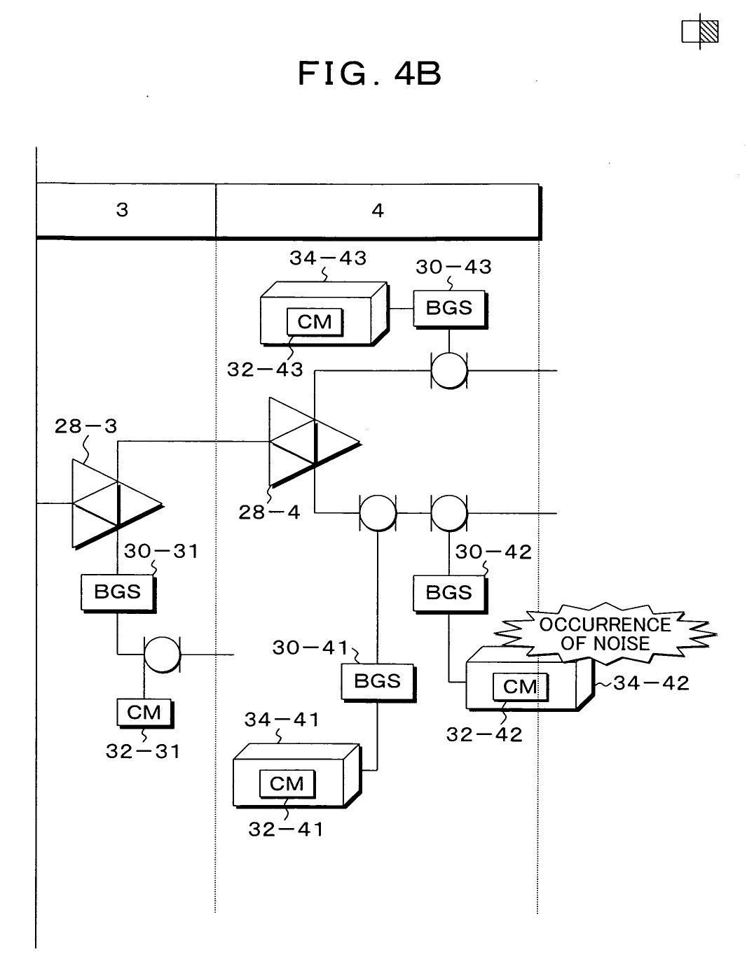

FIGS. 4A and 4B are descriptive drawings that depict one example of the CATV transmission path as a search target of the noise-generation-source searching unit 38 provided to the fault detection server 10 of FIGS. 1A and 1B. In FIGS. 4A and 4B, this CATV transmission path is an optical coaxial transmission path (HFC transmission path) provided with the headend 20 followed by the optical nodes 26-1 and 26-2. The optical nodes 26-1 and 26-2 and thereafter are taken as a coaxial cable transmission path. Transmission devices provided on the CATV transmission path include, in JCTEA standards, for example, a trunk branch amplifier TBA, a trunk distribution amplifier TDA, a branch amplifier BA, a distribution amplifier TA, an extension amplifier EA, and further a splitter that causes a trunk and distribution lines to branch. Here, each amplifier is of a bidirectional amplification type.

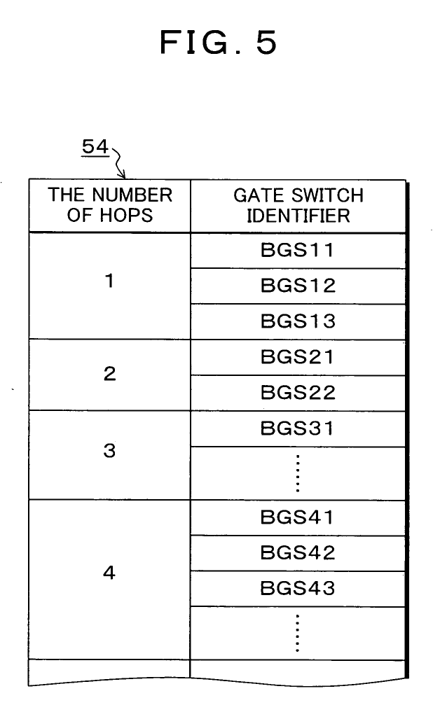

FIGS. 4A and 4B depict a part of the CATV transmission path, provided with TBAs 28-2, 28-3, and 28-4 on a downstream side of the optical node 26-1. To branch lines of the TBA 28-4, devices at subscribers' homes represented as collective housings 34-41 to 34-43 are connected. Also, on a downstream side of the optical node 26-2, a collective housing 34-11 where devices at subscribers' homes are disposed is directly connected. Also, the optical nodes 26-1 and 26-2 have output ports to which gate switches 30-11 and 30-12 are connected, respectively. The TBA 28-2 has two branch ports to which gate switches 30-21 and 30-22 are connected, respectively. The TBA 28-3 has one branch port to which a gate switch 30-31 is connected. Furthermore, the collective housings 34-11 and 34-41 to 34-43 have lead-in portions provided with gate switches 30-13 and 30-41 to 30-43, respectively. Still further, at midpoints on the branch lines in the CATV transmission path, cable modems 32-21, 32-22, and 32-31 are provided. Although one cable modem is provided for each subscriber's device in the collective housings 34-11 and 34-41 to 34-43 as a collection of subscribers' homes, such cable modems are represented herein by the cable modems 32-11 and 32-41 to 32-43. Searching for a noise generation source through a control over the gate switches by the noise-generation-source searching unit 38 depicted in the fault detection server 10 of FIGS. 1A and 1B is performed by using a gate-switch management list 54 depicted in FIG. 5. In FIG. 5, the gate-switch management list 54 is configured of the number of hops and gate switch identifiers. The number of hops is a value counted up every time an active device is passed through toward a downstream side with an optical node on a CATV transmission path as a starting point. For example, with the CATV transmission path of FIG. 5 being taken as an example, as depicted in an upper portion, 1, 2, 3, and 4 are set each as the number of hops. That is, the number of hops=1 on an output port side of the optical nodes 26-1 and 26-2 including the gate switches 30-11, 30-12, and 30-13. This is represented by gate switch identifiers BGS11 to 13 in the gate-switch management list 54 of FIGS. 4A and 4B. Then, on a branch port side of the TBA 28-2, the number of hops=2. Here, the gate switches 30-21 and 30-22 are present. In the gate-switch management list 54 of FIG. 5, corresponding to the number of hops=2, gate switch identifiers BGS21 and 22 are registered. Then, for the branch port of the TBA 28-3, the number of hops=3. In the gate-switch management list 54 of FIG. 5, corresponding to the number of hops=3, a gate switch identifier BGS31 is registered. Then, on a branch port side of the TBA 28-4, the number of hops=4. In the gate-switch management list 54, corresponding to the number of hops=4, gate switch identifiers BGS41 to 43 are registered. In the noise-generation-source searching unit 38 of FIGS. 1A and 1B, when a detection of a decrease in upstream transmission quality is obtained by the upstream-transmission-quality monitoring unit 36, the gate switches are sequentially controlled for each number of hops on the gate-switch management list 54 of FIG. 5 to search for an upstream-ingress-noise generation source. Specifically, the gate switch identifier BGS11 that belongs to the number of hops=1 is first obtained, a control command for attenuator insertion is sent to the gate switch 30-11 of FIGS. 4A and 4B, and then an attenuator is inserted and connected to obtain the S/N ratio of the upstream port 24. When the S/N ratio is increased, it is determined that a noise generation source is present on a downstream side of the gate switch 30-11. Then, the gate switch identifier BGS12 is obtained from the gate-switch management list 54, a control command for attenuator insertion is sent to the gate switch 30-12, and then an attenuator is inserted and connected to obtain the S/N ratio of the upstream port 24. At this time, if the S/N ratio is not changed, it is determined that a noise generation source is not present on a downstream side of the gate switch 30-12, and any gate on the downstream side is ignored. Therefore, a control over the gate switch 30-13 is not performed. For the gate switch 30-11 for which it is determined that a noise generation source is present on the downstream side with the number of hops=1, the gate switches 30-21 and 30-22 corresponding to the gate switch identifiers BGS21 and 22 on the gate-switch management list 54 of FIG. 5 with the number of hops=2 are controlled next. For the gate switch 30-21, an attenuator is inserted based on a control command to obtain the S/N ratio of the upstream port 24. In this case, if the S/N ratio is not changed, it is determined that a noise generation source is not present on a downstream side of the gate switch 30-21, and this gate switch is ignored. Next, a control command is sent to the gate switch 30-22 corresponding to the gate switch identifier BGS22 to obtain the S/N ratio of the upstream port 24 with attenuator on. At this time, if the obtained S/N ratio is increased, it is determined that a noise generation source is present on a downstream side of the gate switch 30-22, and then the procedure goes to the next process with the number of hops=3. In the process with the number of hops=3, a control command is sent to the gate switch identifier BGS30-31 on a downstream side of the gate switch 30-22 to obtain the S/N ratio of the upstream port 24 with attenuator on. In this case, if the SIN ratio is not changed, a downstream side of the gate switch 30-31 is ignored. Then, the procedure goes to a process with the number of hops=4. From the gate-switch management list 54, the gate switch identifier BGS44 is obtained with the number of hops on a downstream side of the gate switch 30-22 for which it is determined that a noise generation source is present with the number of hops=2. The gate switches 30-41 to 30-43 corresponding to the number of hops=4 are sequentially controlled. In this case, for the gate switches 30-41 and 30-43, when the S/N ratio of the upstream port 24 is not changed even with attenuator on by a control command but the S/N ratio of the upstream port 24 is increased with attenuator on for the gate switch 30-42 by a control command, since the number of hops is not present for the gate switch 30-42, a search result is obtained such that an ingress-noise generation source is on a downstream side of the gate switch 30-42. Specifically, since a collective housing 34-42 is present on the downstream side of the gate switch 30-42, the collective housing 34-42 is specified as an upstream-ingress-noise generation source. Here, the functions of the upstream-transmission-quality monitoring unit 36 provided to the fault detection server 10 depicted in FIGS. 1A and 1B, the noise-generation-source searching unit 38, the cable-modem processing unit 42, and the fault notifying unit 40 are functions achieved by a computer executing a program. Therefore, a computer configuring the fault detection server 10 has a CPU as a hardware environment. Connected to a bus of the CPU are a RAM, a ROM, a hard disk drive, a display, a keyboard, a mouse, and a network adaptor. In the hard disk drive, a program for monitoring upstream ingress noise according to the present embodiment is stored. When this computer is activated, with a boot process after self-diagnosis and an initialization process by BIOS, an OS is read and placed onto the RAM. Then, the program for monitoring upstream ingress noise according to the present embodiment is read and placed onto the RAM and is executed by the CPU.

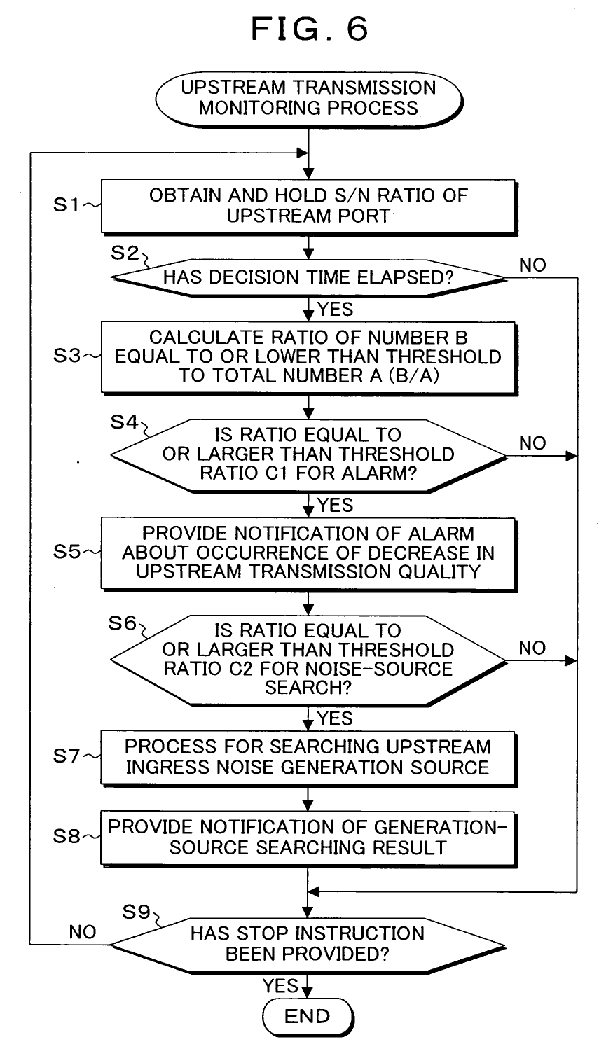

FIG. 6 is a flowchart depicting a process of monitoring upstream transmission quality in the present embodiment, and is described with reference to FIGS. 1A and 1B as follows.

In FIG. 6, in step S1, the upstream-transmission-quality monitoring unit 36 of the fault detection server 10, an S/N ratio of the upstream signal in a use band of the upstream port 24 from the headend 20 in the cable router apparatus 18 is obtained and held for every T1=1 second as depicted in FIG. 3, for example. When it is determined in step S2 that the predetermined decision time T2 has elapsed, the ratio of the number B of obtained S/N ratios equal to or smaller than the threshold TH with respect to the total number A of obtained S/N ratios (B/A) is calculated in the step S3. Then, in step S4, it is determined whether the ratio is equal to or larger than the threshold ratio C1 for alarm, for example, C1=0.6. If the ratio is equal to or larger than the threshold ratio C1, a notification of an alarm indicating the occurrence of a decrease in upstream transmission quality is provided to the fault analyzing server 12 in step S5 via the fault notifying unit 40, thereby alarming the client 16 side about the decrease in upstream transmission quality. Then, it is checked in step S6 whether the calculated ratio (B/A) is equal to or larger than the threshold ratio C2 for noise-source search, for example, C2=0.7. If the ratio is equal to or larger than the threshold ratio C2, a searching process by the noise-generation-source searching unit 38 is executed in step S7. Then, in step S8, the fault analyzing server 12 is notified via the fault notifying unit 40 of the generation-source search result, which is then stored in the database 14 and reported to the client 16 side at the same time, thereby specifying an upstream-ingress-noise generation source and causing a measure for eliminating noise to be taken. These processes in steps S1 to S8 are repeated until a stop instruction, such as logoff, is provided in step S9.

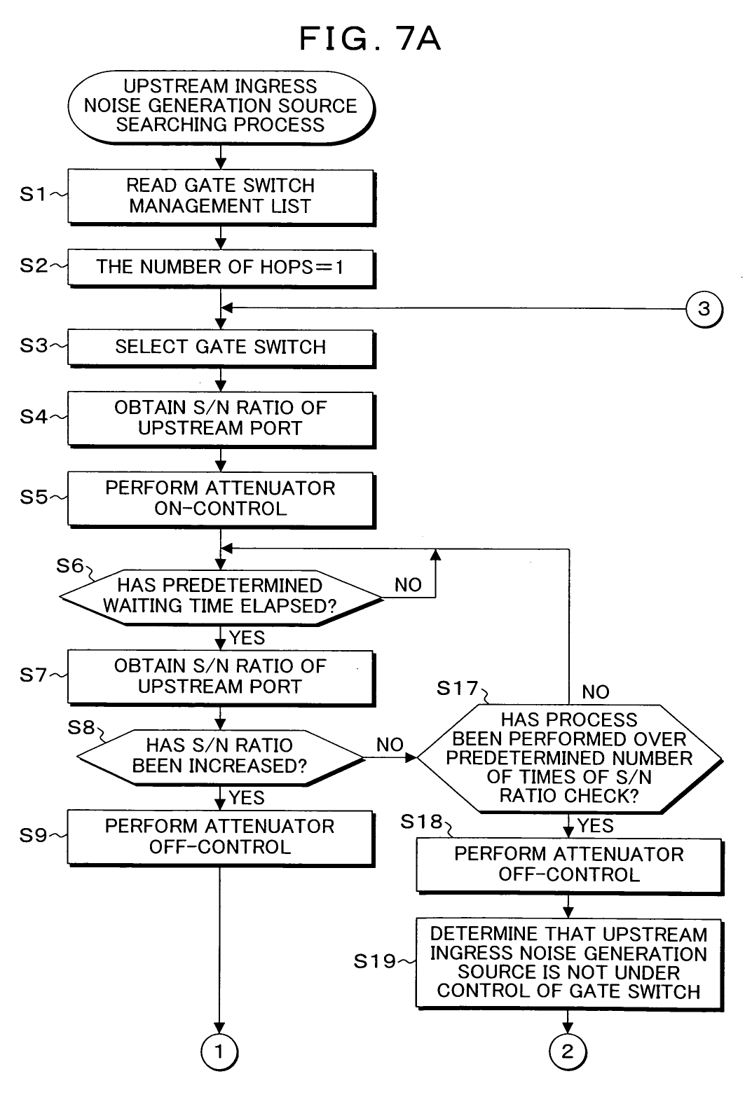

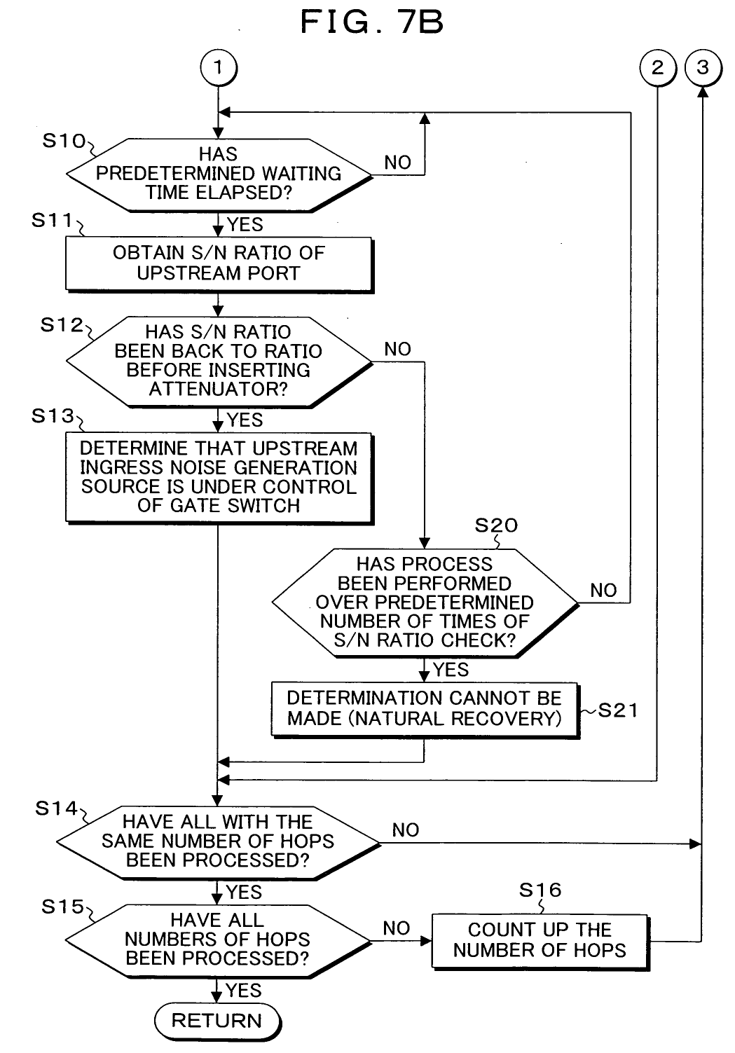

FIGS. 7A and 7B are flowcharts depicting details of the process of searching for an upstream-ingress-noise generation source in step S7 of FIG. 6. In FIGS. 7A and 7B, in the process of searching for an upstream-ingress-noise generation source, the gate-switch management list 54 as depicted in FIG. 5 is first read in step S1. In step S2, the number of hops=1 is set as an initial value. Then in step S3, one of the target gate switches corresponding to the number of hops=1 is selected. In step S4, the S/N ratio of the upstream port 24 before control is obtained. Then in step S5, an attenuator-on control command is transmitted to the selected gate switch. Then in step S6, the procedure waits until a predetermined waiting time has elapsed. In step S7, the S/N ratio of the upstream port is obtained. Here in the present embodiment, after the attenuator-on control command is sent to the gate switch, as clearly described in the following description, the procedure goes to the next process after the completion of operation of the gate switch is confirmed. In step S7, the S/N ratio of the upstream port 24 is obtained with the gate switch being switched as attenuator on. In step S8, it is checked whether the S/N ratio has been increased. At this time, if a noise generation source is present on the downstream side of the gate switch controlled as attenuator on, the upstream signal containing upstream ingress noise due to the insertion of an attenuation resistor based on attenuator on is attenuated, thereby increasing the S/N ratio at the upstream port 24. Therefore, if an increase in the S/N ratio is determined in step S8, the procedure goes to step S9, where an attenuator-off control command is sent to the gate switch. In step S10, after a predetermined waiting time has elapsed, the S/N ratio of the upstream port 24 is obtained in step S11. When it is determined in step S12 that the obtained S/N ratio has been back to the ratio before inserting the attenuator, it is determined in step S13 that an upstream-ingress-noise source is present under the currently-selected gate switch. On the other hand, when the SIN ratio of the upstream port 24 is not changed in step S8 even with the attenuator-on control over the gate switch in step S5, the processes in steps S6 to S8 are repeated until they have been performed over a predetermined number of times of S/N-ratio check. If the processes have been performed over the number of times of S/N-ratio check in step S17, the procedure goes to step S18, where an attenuator-off control command is sent for switching. Thereafter, it is determined in step S19 that an upstream-ingress-noise source is not present under the currently-selected gate switch. Also, when the S/N ratio of the upstream port 24 obtained after the attenuator-off control is not back to the value before attenuator insertion in step S12, the procedure goes to step S20, where the processes in steps S10 to S12 are repeated until they have been performed over a predetermined number of times of S/N-ratio check. In this state, if the processes have been performed over the number of times of check, the procedure goes to step S21. Since the S/N ratio is recovered, it is determined that a noise source has been eliminated due to natural recovery, for example, and, in this case, a determination cannot be made, and then the procedure goes to step S14. In step S14, it is checked whether all gate switches with the same number of hops have been processed and, if any has been unprocessed, the procedure returns to step S3 for repeating similar processes by selecting the next gate switch. If completion of processing all of the gate switches with the same number of hops is determined in step S14, the procedure goes to step S15, where is checked whether all numbers of hops have been processed. If any has been unprocessed, the number of hops is counted up in step S16, and then the procedure returns to step S3 for repeating similar processes for the next number of hops. If it is determined in step S15 that all numbers of hops have been processed, the series of processes of searching for an upstream-ingress-noise generation source ends, and then the procedure returns to the main routine in FIG. 6.

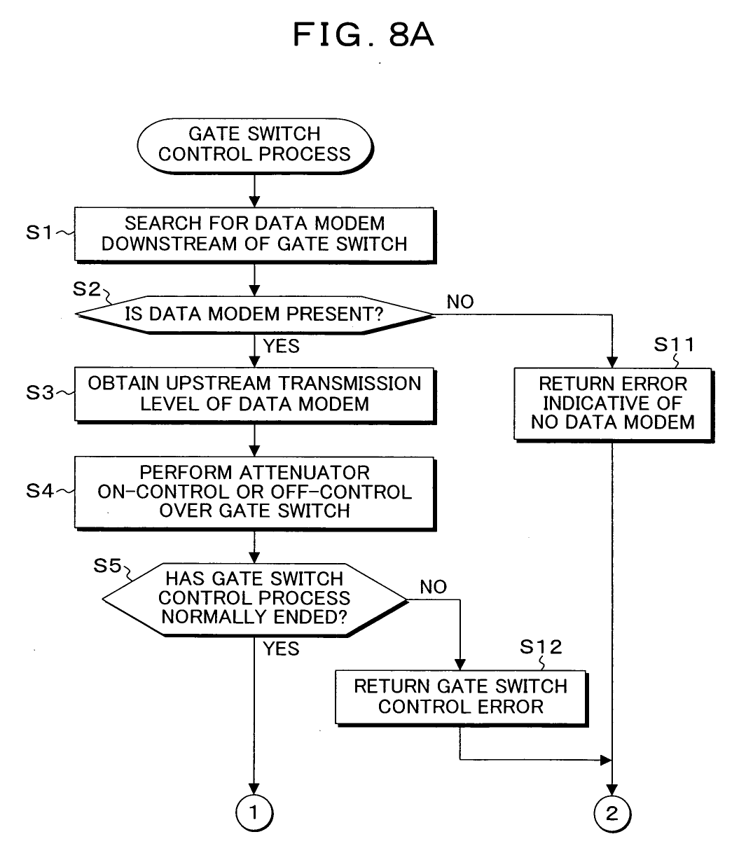

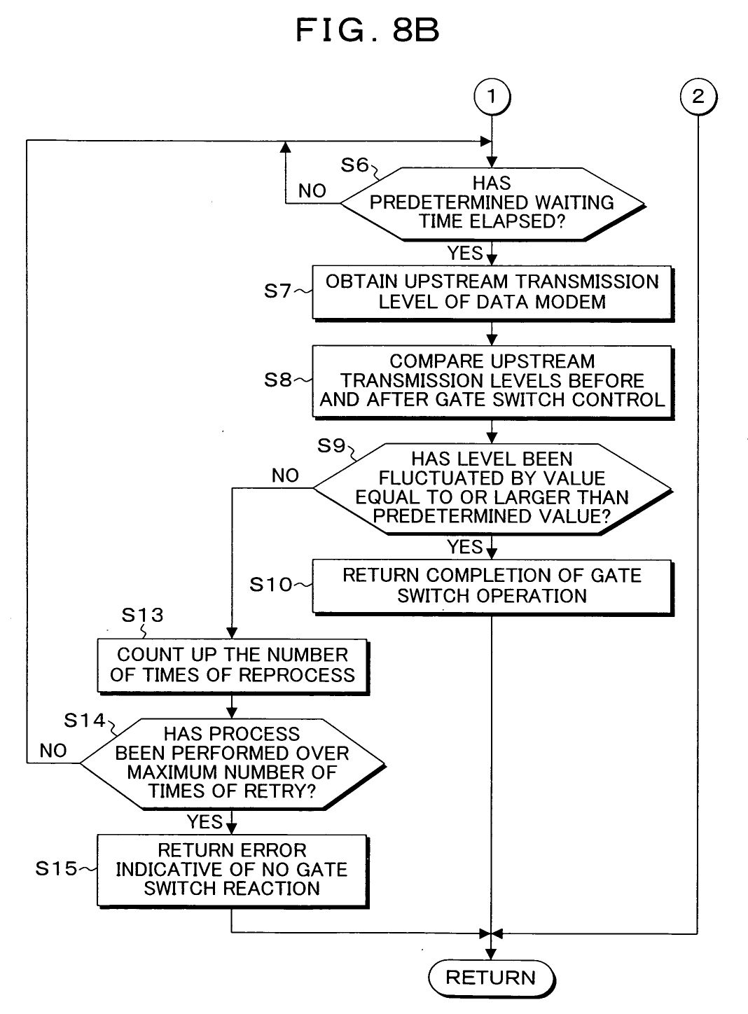

FIGS. 8A and 8B are flowcharts depicting a gate-switch operation check process using cable modems in the present embodiment. The gate-switch operation check process of FIGS. 8A and 8B is a process performed during the elapse of the predetermined waiting time in steps S6 and S10 after issuance of a control command in the attenuator-on control in step S5 and the attenuator-off control in step S9 in the process of searching for an upstream-ingress-noise generation source of FIGS. 7A and 7B.

In FIGS. 8A and 8B, in the gate-switch operation check process, a search is made in step S1 for a data modem downstream of the target gate switch. If there is a data modem downstream in step S2, the procedure goes to step S3, where an upstream transmission level of the data modem present downstream is obtained. The upstream transmission level of the data modem can be obtained from the cable-modem processing unit 42 of FIGS. 1A and 1B. The cable-modem processing unit 42 collects measurement values in a transmission state measured by cable modems present on the CATV transmission path in a polling cycle of thirty seconds, for example. As cable modems collecting the measurement values in this transmission state by polling, those in DOCSIS 1.0 and 1.1 are used. As a polling protocol, SNMPv2C is used to collect MIB information of the cable modems. Specifically, after point information of a cable modem for polling is obtained at the cable router apparatus 18, reception information of the cable modem is individually polled. For this reason, for polling one cable modem by the cable-modem processing unit 42 of the fault detection server 10, two sets of an SNMP get-request PDU and an SNMP get-response PDU are required. Measurement values collected from the cable modem on the CATV transmission path through polling by the cable-modem processing unit 42 of the fault detection server 10 include the followings:
(1) Downstream reception level;
(2) Upstream transmission level;
(3) Upstream reception level;
(4) Downstream S/N;
(5) Upstream SIN;
(6) Downstream code word error; and
(7) Upstream code word error.

Therefore, to obtain the upstream transmission level of the data modem in step S3 of FIGS. 8A and 8B, an upstream transmission level obtained for the data modem downstream of the currently-targeted gate switch obtained from the cable-modem processing unit 42 is obtained. Then in step S4, an attenuator-on or attenuator-off control command is transmitted to the gate switch based on an instruction to the BGS controller 22. Then in step S5, it is checked whether the command control by the BGS controller 22 has normally ended. If the control has normally ended, it is determined in step S6 whether a predetermined waiting time has elapsed. Then in step S7, the upstream transmission level of the data modem placed on a downstream side of the gate switch is obtained again. Then in step S8, the upstream transmission level before gate-switch control obtained in step S3 and the upstream transmission level after gate-switch control obtained in step S7 are compared with each other. If a fluctuation equal to or larger than a predetermined value is found in step S9, completion of operation of the gate switch is returned in step S10. Here, a reason for fluctuations in upstream transmission level of a data modem placed on a downstream side when the gate switch is caused to perform an attenuator-on or attenuator-off control operation is described.

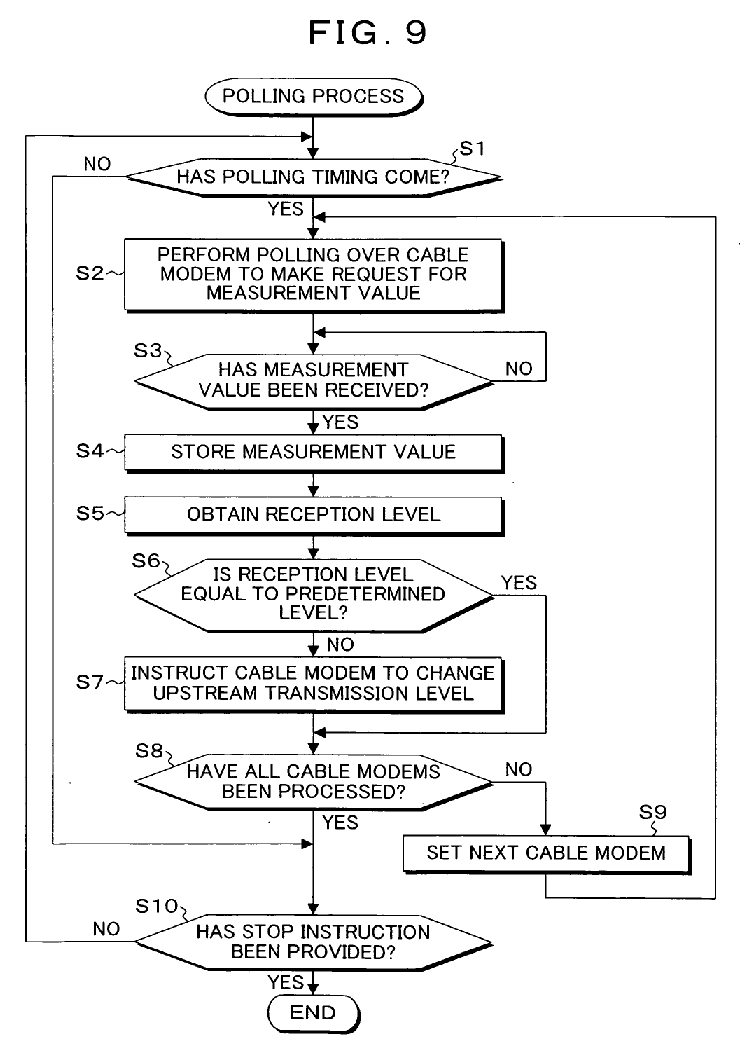

FIG. 9 is a flowchart depicting a polling process performed at the cable-modem processing unit 42 provided in the fault detection server 10 of FIGS. 1A and 1B. In the polling process of FIG. 9, when it is determined in step S1 that a predetermined polling time, for example, once in thirty seconds, has come, the cable modems placed on the CATV transmission path are requested in step S2 for a response of a measurement value. For this measurement-value response request, when it is determined in step S3 that the measurement value has been received, the received measurement value is stored in step S4. Then in step S5, it is checked whether all cable modems have been processed and, if any has been unchecked, the next cable modem is set in step S6 and the processes from step S2 are repeated. Then, such processes in steps S1 to S6 are repeated until a stop instruction, such as logoff, is provided in step S7. In this manner, when the upstream signal with the measurement value transmitted as a response from the cable modem with respect to the polling from the cable-modem processing unit 42 of the fault detection server 10 is received by the cable router apparatus 46, if the reception level of the received upstream signal does not match a predetermined defined level, the cable router apparatus 46 performs a feedback control of making an instruction for a control of changing the upstream transmission level for matching the reception level of the cable modem of the transmission source with the defined level. Here, in the gate-switch control process in FIGS. 8A and 8B, when an attenuator-on or attenuator-off control is performed in step S4, for example, when an attenuation resistor is inserted in the transmission path based on attenuator on, the reception signal level of the measurement value transmitted as a polling response from the cable modem positioned downstream of the gate switch is decreased due to the insertion of the attenuation resistor based on attenuator on. Upon this decrease in reception level, the cable router apparatus 46 instructs the cable modem of the transmission source to change the upstream transmission level so that the decreased reception level is recovered to the defined level. Therefore, when the upstream transmission level of the data modem is obtained in step S7 after an attenuator-on control is performed on the gate switch in step S4 of FIGS. 8A and 8B, for example, an increase is found in the upstream transmission level after control, compared with the upstream transmission level before control obtained in step S3. Therefore, it is determined in step S9 that a fluctuation equal to or larger than the predetermined value is present and, in step S10, completion of the operation of the gate switch can be returned. On the other hand, when the gate switch is subjected to an attenuator-off control, an increase is found in reception level after the attenuator-off control, compared with the reception level before control in an attenuator-on state, and it is also determined that a fluctuation equal to or larger than the predetermined value is present. Thus, completion of the operation of the gate switch for which an instruction for the attenuator-off control is made can be determined and returned. In this manner, in the gate-switch control process of FIGS. 8A and 8B, the upstream transmission levels before and after control of the cable modem positioned downstream of the gate switch selected as a control target are obtained. Based on whether a fluctuation equal to or larger than the predetermined value is present, it is possible to check whether the operation has been normal. Referring again to FIGS. 8A and 8B, when no data modem is present on the downstream side of the gate switch selected as a control target in step S2, an error indicative of no data modem is returned in step S11. In this case, the process of searching for an upstream-ingress-noise generation source of FIGS. 7A and 7B is repeated without checking completion of the operation of the gate switch. Also, if the control process has not normally ended in step S5 in response to an instruction for control command transmission to the BGS controller 22, a BGS control error is returned in step S12. Furthermore, when it is determined in step S9 that a fluctuation in upstream transmission level of the data modem equal to or larger than the predetermined value is not present before and after control of the gate switch, the procedure goes to step S13, where the number of times of reprocess is counted up, and the processes in steps S6 to S13 are repeated until they have been performed over a maximum number of times of retry in step S14. When it is determined in step S14 that the processes have been performed over the maximum number of times of retry, an error indicative of no gate switch reaction is returned. If an error occurs in step S10, S12, or S15, the procedure goes to the next process without checking the operation of the gate switch.

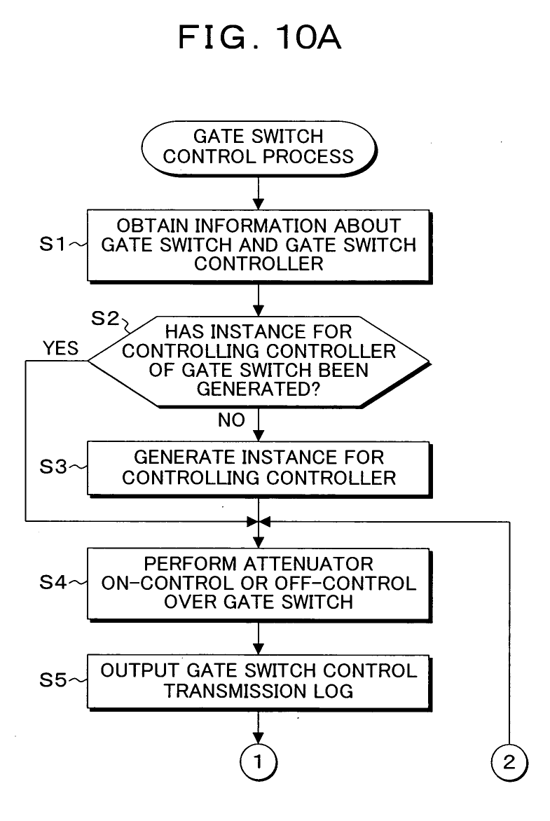

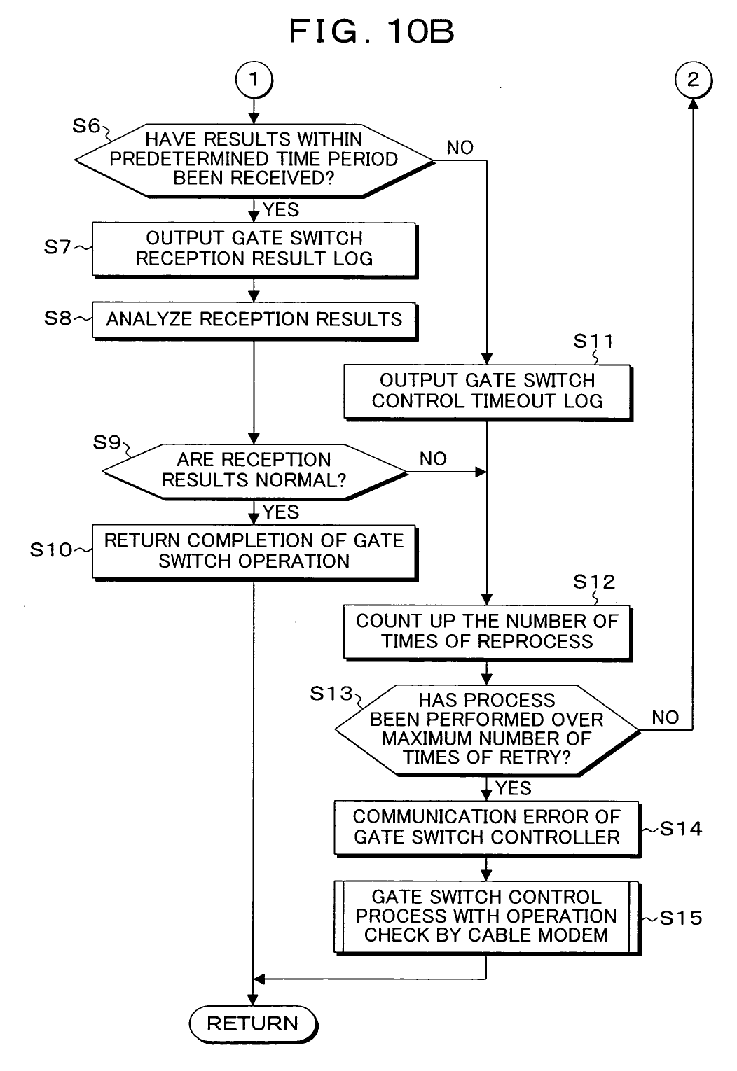

FIGS. 10A and 10B are flowcharts depicting a gate-switch control process according to another embodiment in the present embodiment, wherein a function of returning a switch-operation-complete response to a gate switch is provided. In FIGS. 10A and 10B, in the gate-switch control process targeted for the gate switch having a function of returning an operation-complete response, after information about the gate switch and the gate switch controller 22 is obtained in step S1, it is checked in step S2 whether an instance for controlling the controller of the target gate switch has been generated. If not yet generated, the instance is generated in step S3. Then in step S4, an instruction is provided for transmitting an attenuator-on or attenuator-off control command for the target gate switch. Then in step S5, a gate-switch-control transmission log is obtained from the BGS controller 22 for output. In step S6, it is checked whether the results within a predetermined time period have been received. If the results have been received within the predetermined time period, a gate-switch reception result log is output in step S7. The reception results are analyzed in step S8. If the reception results are normal in step S9, completion of the operation of the gate switch is returned in step S10. On the other hand, if the results within the predetermined time period have not been able to be received in step S6, a gate-switch-control timeout log is output in step S11. Then in step S12, the number of times of retry is counted up. The processes in steps S4 to S6, S11, and S12 are repeated until they have been performed over a maximum number of times of retry in step S13. If the processes have been performed over the maximum number of times of retry in step S13, it is determined in step S14 that a communication error has occurred in the BGS controller 22. In this case, a gate-switch-control process with an operation check by the cable modem is performed in step S15. This gate-switch-control process with an operation check by the cable modem in step S15 is as depicted in the flowchart of FIGS. 7A and 7B.

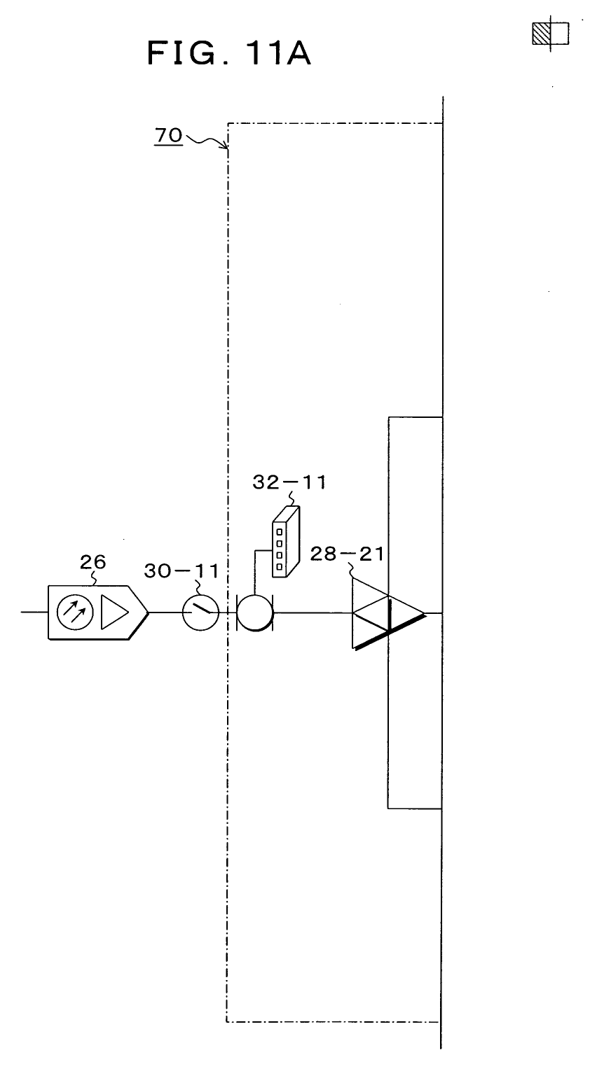

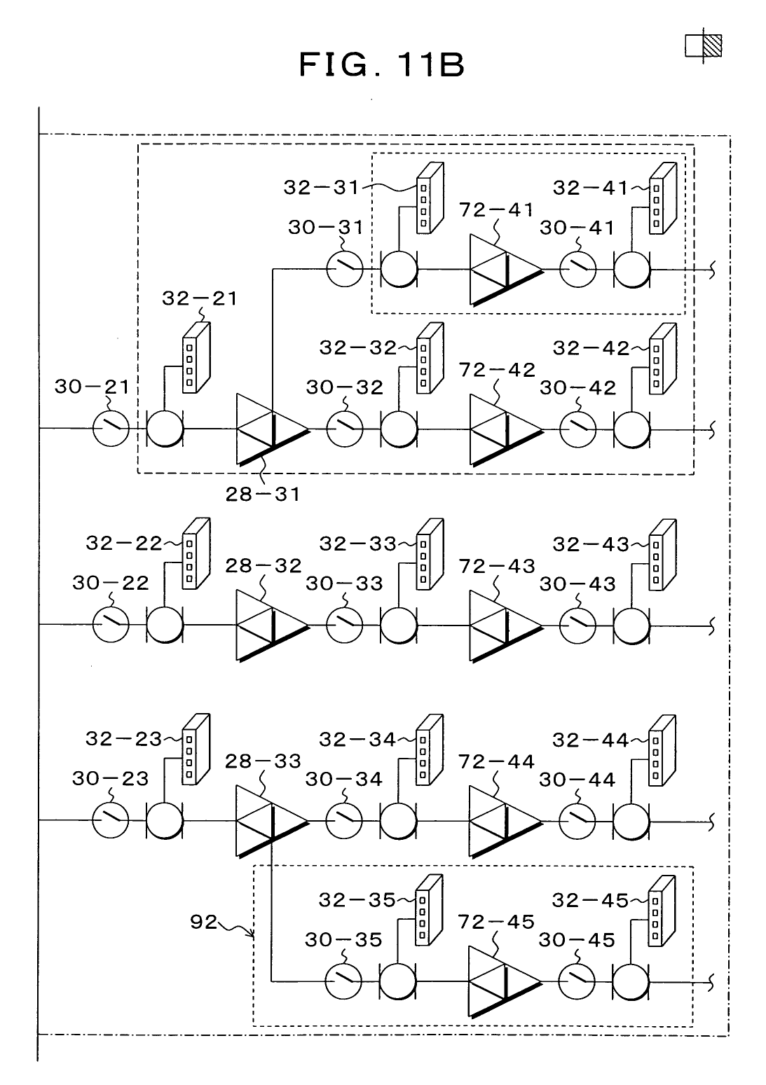

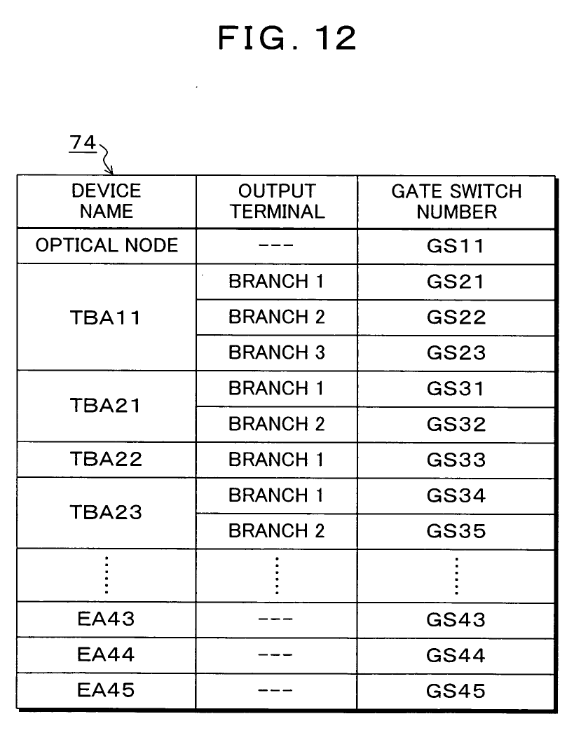

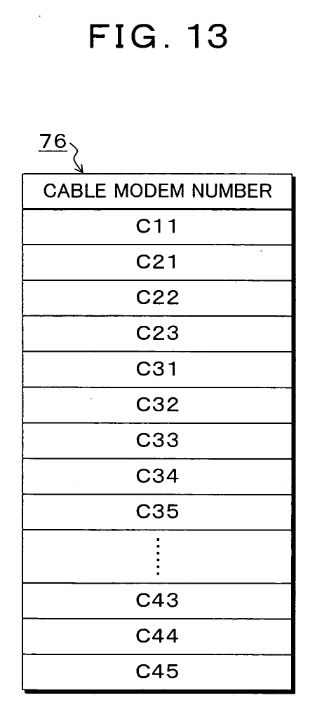

FIGS. 11A and 11B are descriptive drawings that depict one example of a CATV transmission path for which a transmission-path map is generated according to the present embodiment. In the upstream-ingress-noise monitoring system according to the present embodiment depicted in FIGS. 1A and 1B, the transmission-path-map generating unit 44 is provided to the fault detection server 10. The transmission-path-map generating unit 44 sequentially controls the gate switches placed in each output port of a plurality of transmission-path devices provided on the CATV transmission path to change the amount of attenuation of the upstream signal and, accordingly, with a control for keeping the changed upstream-signal reception level constant by the cable router apparatus 18, detects a cable modem with a changed upstream-signal transmission level, thereby generating a transmission-path map for the transmission-path device. In the noise-generation-source searching unit 38 provided in the fault detection server 10 of FIGS. 1A and 1B, in searching for an upstream-ingress-noise generation source, it is assumed to use a transmission-path map indicating an arrangement of transmission-path devices on the target CATV line for performing a searching process. However, depending on the CATV transmission path, there may not be a transmission-path map for use in searching for an upstream-ingress-noise generation source, or if it is present, it may be an old transmission-path map different from the actual transmission-path state. In such cases, in the transmission-path-map generating unit 44 according to the present embodiment, the gate switches disposed on the CATV transmission path are sequentially operated, thereby automatically generating a transmission-path map. The transmission-path-map generating unit 44 has a functional structure including a correspondence-list generating unit that generates a correspondence list having registered therein a correspondence relation between one or a plurality of cable modems and gate switches where the upstream-signal transmission level has been changed, the correspondence list being generated through a sequential control over all gate switches disposed on the CATV transmission path, and a parent-child-relation determining unit that determines a parent-child relation among all gate switches to generate a transmission-path map. A function of the process of the transmission-path-map generating unit 44 in the present embodiment is explained in detail as follows. First, consider a case as an example where a transmission-path map is automatically generate for a CATV transmission path 70 as depicted in FIGS. 11A and 11B. In the CATV transmission path 70 of FIGS. 11A and 11B, an optical node 26 is followed by a TBA (trunk branch amplifier) 28-21 being disposed. The TBA 28-21 has three branch terminals to which TBAs 28-31, 28-32, and 28-33 are connected. One of two branch terminals of the TBA 28-31 has an EA (extension amplifier) 72-41 connected thereto, and the other has an EA 72-42 connected thereto. The TBA 28-32 has a lead only from one output of branch terminals, and an EA 72-43 is provided on that line. Furthermore, the TBA 28-33 has two branch terminals provided with EAs 72-44 and 72-45, respectively. The optical node 26, the TBAs 28-21 and 28-31 to 28-33, and the EAs 72-41 to 72-45 have output ports provided with gate switches 30-11 to 30-45, respectively. Furthermore, on an output side of the gate switches 30-11 to 30-45, cable modems 32-11 to 32-45 are provided. In generation of a transmission-path map for the CATV transmission path 70 as depicted in FIGS. 11A and 11B according to the present embodiment, transmission-device information 74 depicted in FIG. 12 and cable-modem information 76 depicted in FIG. 13 are prepared in advance for reading. The transmission-device information 74 of FIG. 12 includes device names, output terminals and gate switch numbers of gate switches disposed at their output ports. For example, when the target is the CATV transmission path 70 of FIGS. 11A and 11B, for device name “optical node”, a gate switch number of GS11 indicative of the gate switch 30-11 is registered. Also, for the next TBA 28-11, TBA11 is registered as a device name, and three branches 1 to 3 are included as output terminals, respectively. Correspondingly to the gate switches 30-21 to 30-23 provided to branches 1 to 3, respectively, gate switch numbers GS21 to GS23 are registered. In the cable-modem information 76 of FIG. 13, cable modem numbers C11 to C45 correspondingly to the cable modems 32-11 to 32-45 set on the CATV transmission path 70 of FIGS. 11A and 11B are registered.

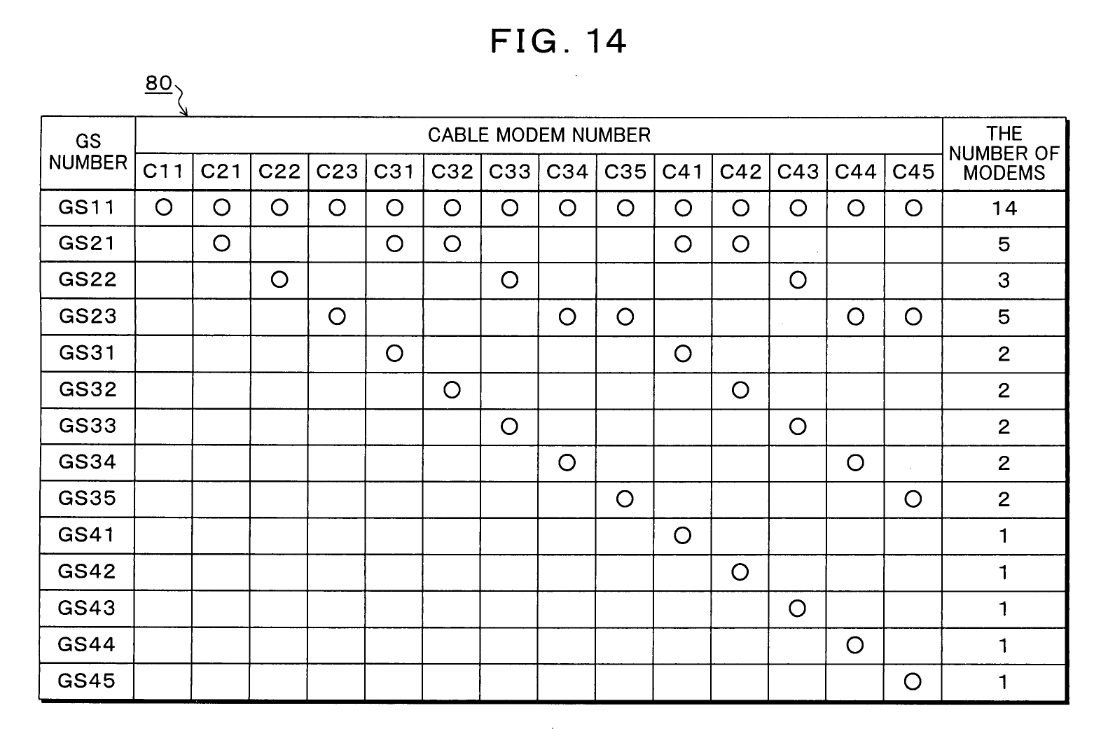

FIG. 14 is a descriptive drawing that depicts a correspondence list generated through attenuator-on/off control of gate switches in a transmission-path-map generating process according to the present embodiment. In FIG. 14, a correspondence list 80 has the gate switch numbers GS11 to GS45 obtained from the transmission-device information 74 depicted in FIG. 12 on the left side as GS numbers, and has the cable modem numbers C11 to C45 obtained from the cable-modem information 76 of FIG. 13 on an upper column. Furthermore, on a left end, a column for the number of modems is provided correspondingly to the GS numbers GS11 to GS45. In the transmission-path-map generation process according to the present embodiment, the correspondence list 80 depicted in FIG. 14 is generated by using a feedback control of controlling a transmission level of the cable modem so as to control the level of the upstream reception signal received by polling the cable modem included in the cable router apparatus 18 depicted in FIGS. 1A and 1B at a constant level. That is, with the gate switch controller 22, the transmission-path-map generating unit 44 causes insertion and separation of an attenuator through a sequential on/off control over the gate switches with the gate switch numbers GS11 to GS45 registered in the correspondence list 80 of FIG. 14. A change in upstream transmission level due to this gate switch control in cable modems positioned on a downstream side is obtained through polling. For each cable modem numbers of the cable modems in which the upstream transmission level has been changed, as represented by circles in FIG. 14, information indicating a change in the level of the upstream transmission signal is registered. For example, in FIGS. 11A and 11B, an attenuator-on control and an attenuator-off control are performed on the gate switch 30-11 provided to an output port of the optical node 26. In this case, for all cable modems 32-11 to 32-45 disposed on a downstream side of the gate switch 30-11, a change in upstream transmission level is detected. Therefore, as depicted in a row of the gate switch number GS11 in FIG. 14, circles indicative a change are registered for all of the corresponding cable modem numbers C11 to C45. In this case, since the number of cable modems in which a change in upstream transmission level is detected is 14, “14” is registered in the number of modems on the right end. Thereafter, similarly, for the gate switch numbers GS21 to GS45 corresponding to the remaining gate switches 30-21 to 30-45, similar attenuator-on control and attenuator-off control are sequentially repeated, a cable modem in which a change in upstream transmission level is changed is detected, and a circle indicative of a change is registered at a position corresponding to the cable modem number of the detected cable modem. When a change registration indicative of the cable modem in which the upstream transmission level is changed in the correspondence list 80 depicted in FIG. 14 through a control over all gate switches in this manner ends, sorting is sequentially performed according to the number of modems.

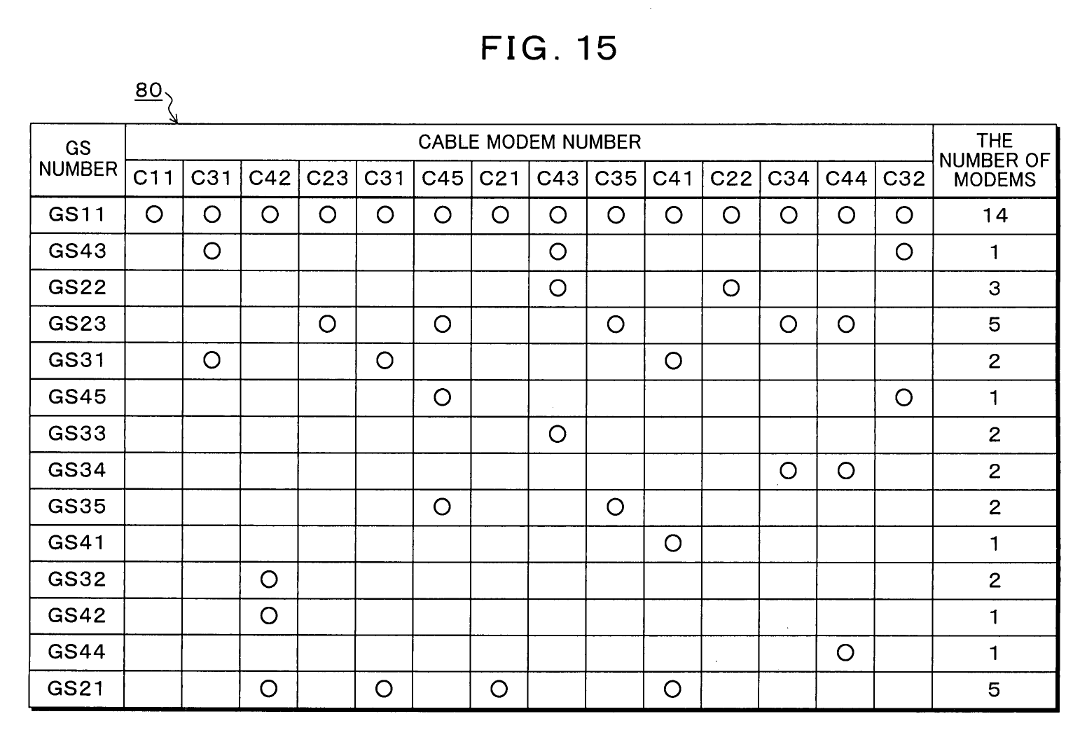

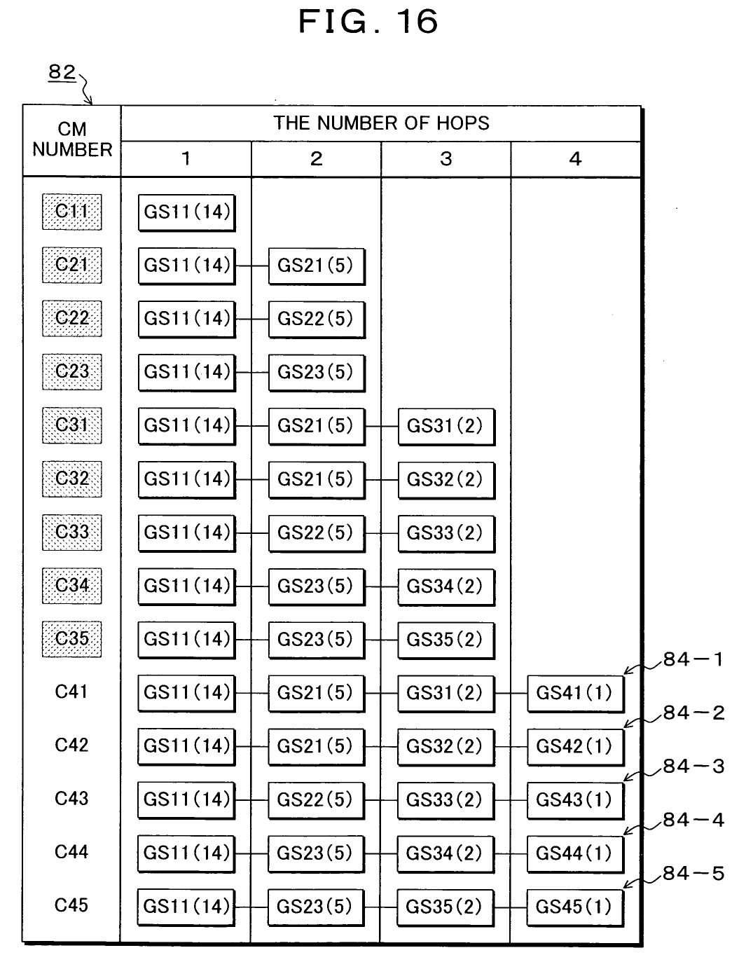

FIG. 15 depicts the correspondence list 80 assumed for actual use, in which GS11 to GS45 presenting gate switch numbers are registered in a random manner, and the cable modem numbers C11 to C45 are also registered in a random manner. In this state, the gate switches are sequentially controlled to detect a cable modem in which the upstream transmission level is changed, and then a registration is made so as to indicate as such with a circle. Then, for each of GS11 through GS21, the number of modems is found as depicted on the right side. Also in this case, when the registered list 80 ends, sorting is performed in the order of the number of modems, thereby obtaining the correspondence list 80 of FIG. 14. Next, as in FIG. 16, based on the correspondence list 80 of FIG. 14, a gate switch arrangement list 82 is generated in which each cable modem numbers C11 to C45 are arranged in the order of the number of hops of the gate switches GS11 to GS45. Next, for the gate switch arrangement list 82, in the order of the cable modem numbers C11 to-C45, if a current target gate switch arrangement is included and there is another gate switch arrangement with the same or more number of hops, the target gate switch arrangement is deleted from determination targets for a parent-child relation. For example, a gate switch arrangement (GS11) of the cable modem number C11 is included in all gate switch arrangements of the cable modem numbers C21 to C45 with a larger number of hops, and therefore the gate switch arrangement is deleted from targets for determining a parent-child relation. With this process being performed, gate switch arrangements of the cable modem numbers C11 to C35 are deleted, and gate switch arrangements 84-1 to 84-5 of the cable numbers C41 to C45 are left as targets for determining a parent-child relation.

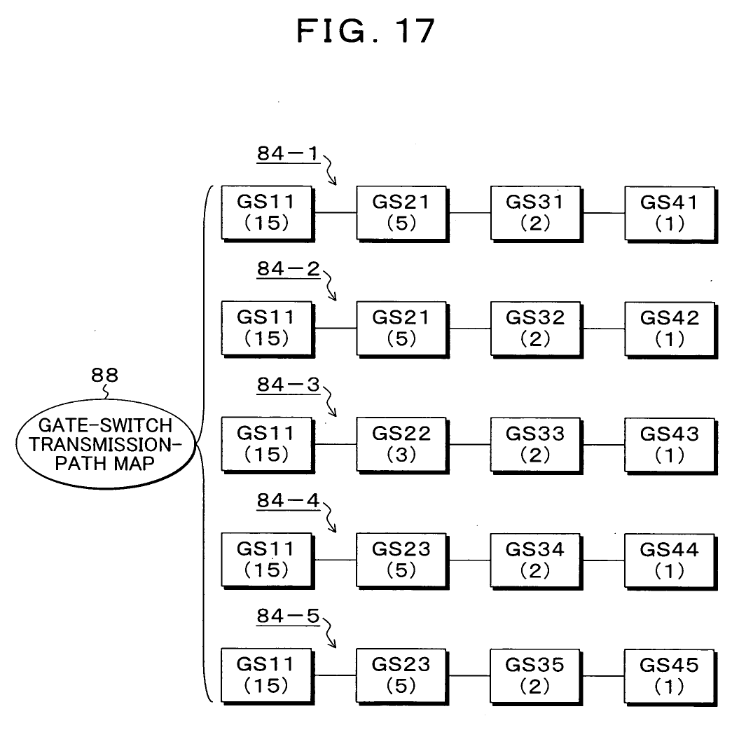

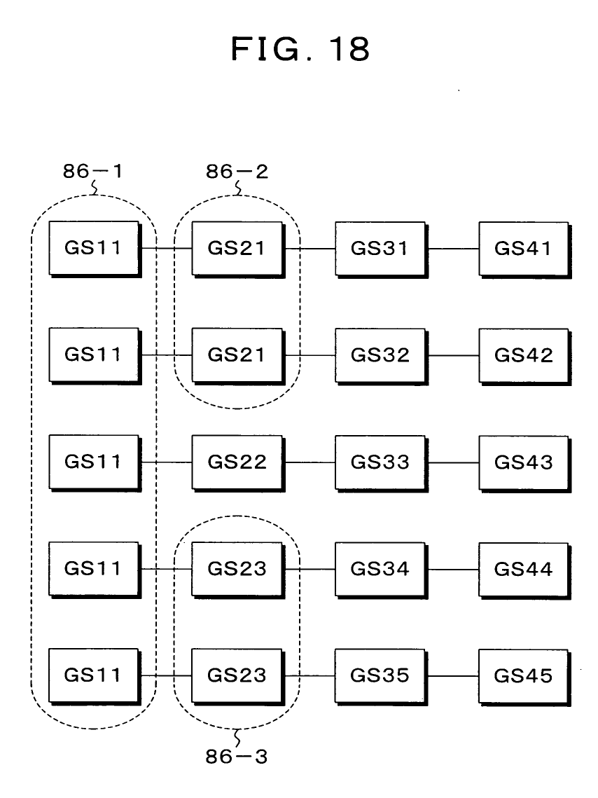

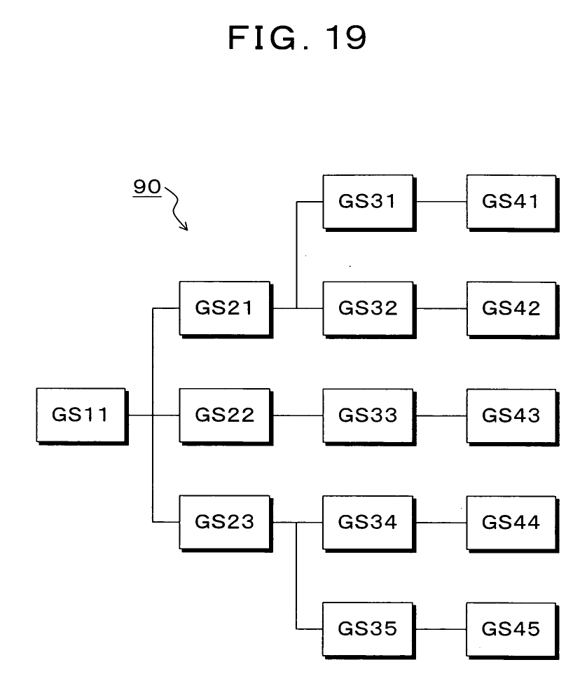

FIG. 17 is a descriptive drawing that depicts a gate-switch transmission-path map 88 in which gate switch arrangements 84-1 to 84-5 left as targets for determining a parent-child relation in FIG. 16 are disposed. When the gate-switch transmission-path map 88 can be generated in this manner, then as depicted in FIG. 18, merge processes 86-1, 86-2, and 86-3 are performed for the same gate switch numbers in each gate switch arrangements 84-1 to 84-5. In this case, five GS11 at the top node are merged into one through the merge process 86-1. Also, two GS21 are merged into one through the merge process 86-2, and two GS23 are merged into one through the merge process 86-3. With these merge processes of FIG. 18, a gate-switch transmission-path map 90 depicted in FIG. 19 can be generated. That is, GS11 is at the top node, and is then branched into three, thereby disposing three GS21 to GS23. Then, GS21 is branched into two, thereby disposing GS31 and 32, where GS41 and GS42 are disposed, respectively. Also, for GS22 at the center, GS33 and GS43 are disposed in a straight line. For GS23, as with a GS21 side, the downstream side is branched into two, thereby disposing GS34 and GS35, where GS44 and GS45 are disposed, respectively. This gate-switch transmission-path map 90 generated as in FIG. 19 has a one-to-one correspondence with an arrangement of the gate switches 30-11 to 30-45 on the CATV transmission path 70, which is unknown on the CATV transmission path 70 of FIGS. 1A and 1B. If the gate-switch transmission-path map 88 as in FIG. 19 has been generated, the transmission-device information 74 depicted in FIG. 12 is used to dispose a transmission-path device specified by a device name at a stage before the corresponding gate-switch number. That is, the gate switch at the bottom node, which comes the last in the gate switch arrangement for each of the cable modem numbers C11 to C45 depicted in FIG. 16, is a gate switch immediately before the target cable mode. Therefore, by referring to the transmission device information 74 of FIG. 12 with the gate switch number, an output terminal of the transmission device where the target cable modem is disposed can be known, thereby disposing the transmission device and the cable modem. For example, the last at the bottom node in the gate switch arrangement 84-5 for C45 is GS45. Therefore, the cable modem for C45 is disposed on a downstream side of the gate switch of GS45, and the EA 45 obtained from the transmission-device information 74 of FIG. 12 is disposed on an upstream side of the gate switch of GS45. With this, even for the unknown CATV transmission path 70, through the transmission-path-map generation process according to the present embodiment, a transmission-path map with the same arrangement with the actual CATV transmission path 70 including transmission-path devices, gate switches, and cable modems can be automatically generated.

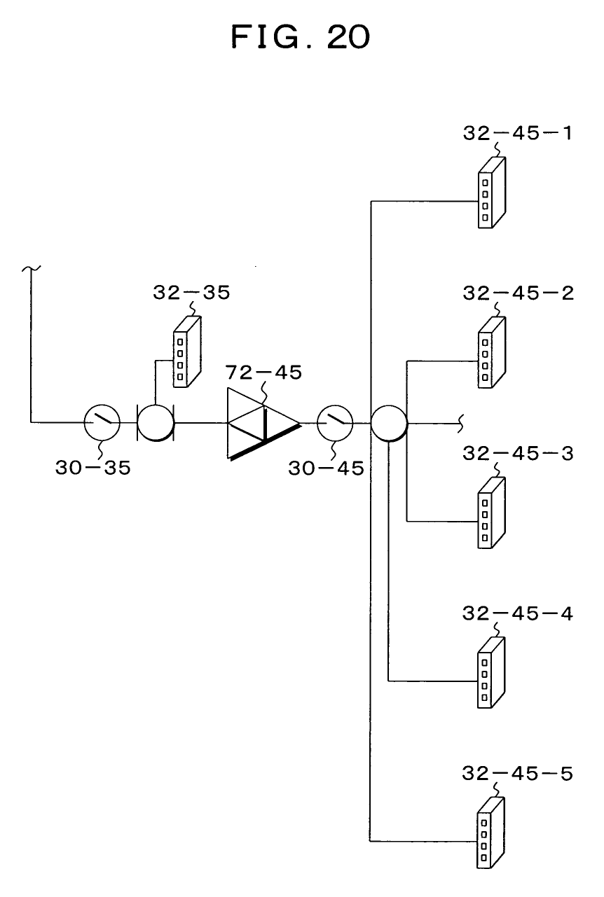

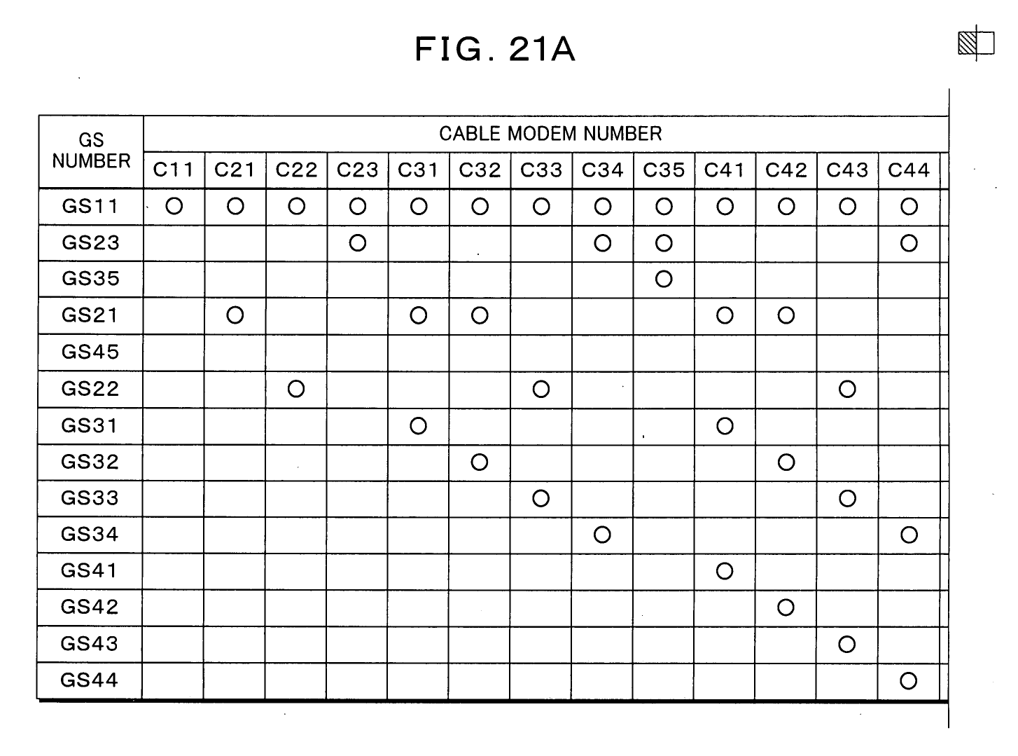

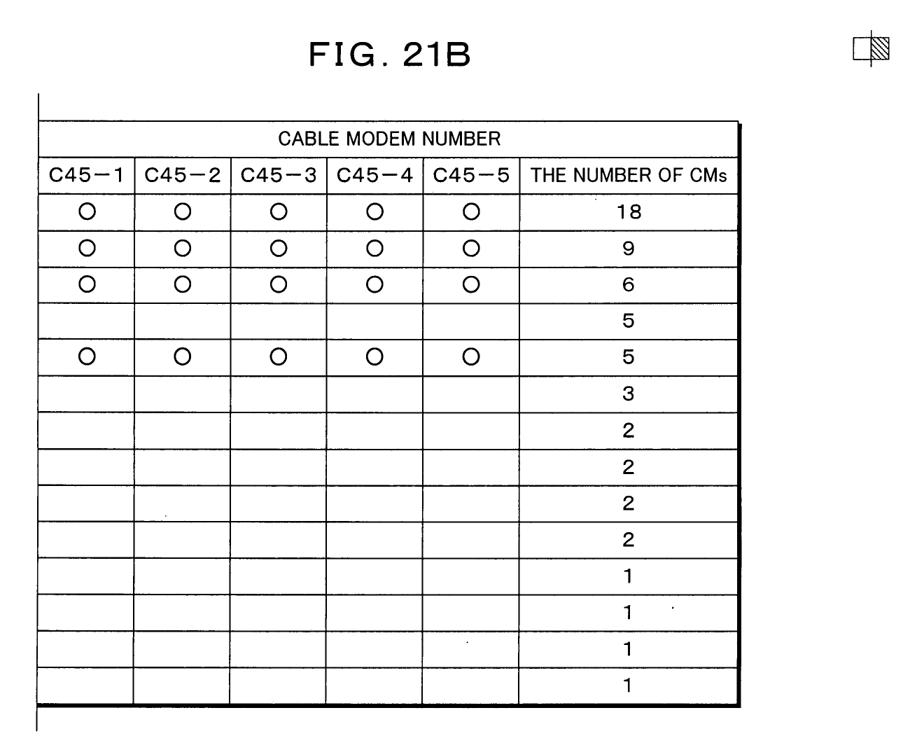

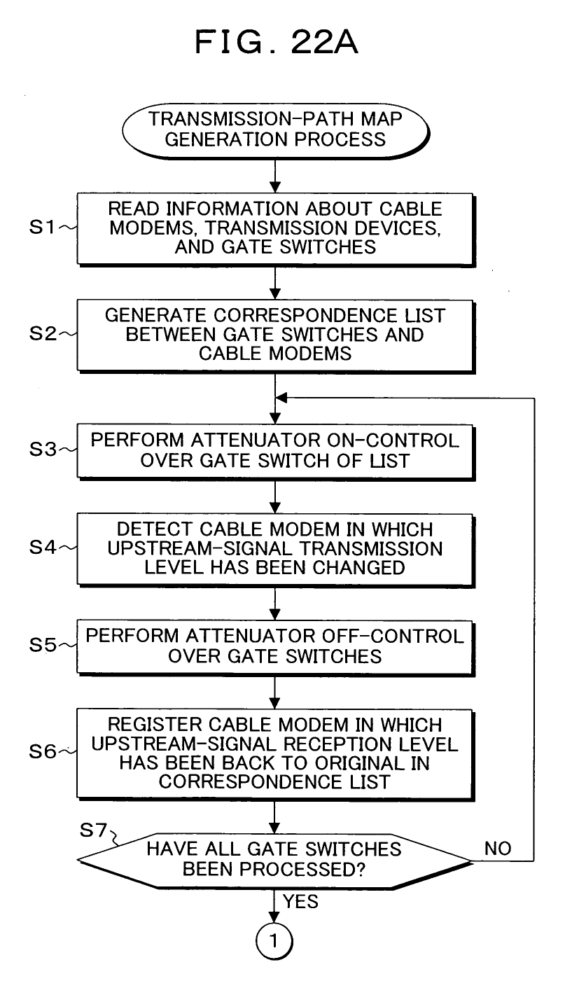

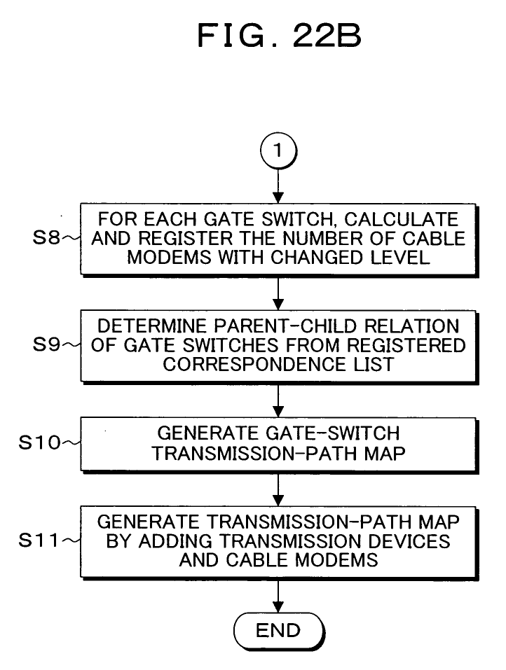

FIG. 20 depicts a modification example in which five cable modems 32-45-1 to 32-45-5 are connected on a downstream side of the gate switch 30-45 in a portion 92 surrounded by a dotted line in the CATV transmission path 70 depicted in FIGS. 11A and 11B. In this case, a correspondence list 94 depicted in FIGS. 21A and 21B is obtained. In the correspondence list 94 of FIGS. 21A and 21B, from one cable modem number C45 in the correspondence list 80 of FIG. 14, there is an increase to five cable modem numbers C45-1 to C45-5. Even as for this correspondence list 94, as with the one depicted in FIG. 16, when a gate switch arrangement is formed for each of the cable modem numbers C11 to C45-5, the arrangements for the cable modem numbers C45-1 to C45-5 are all the same as the gate switch arrangement 84-5, and only one of them is left as a decision target. Then, via the merge processes identical to that in FIG. 18, the gate switch transmission map 90 of FIG. 19 is generated.

FIG. 23 is a flowchart depicting a transmission-path-map generation process according to the present embodiment. In FIG. 23, in the transmission-path-map generation process, as depicted in FIGS. 12 and 13, information about cable modems, transmission devices, and gate switches is read in step S1. In step S2, a correspondence list 80 indicating a correspondence relation between the gate switches and the cable modems is generated as depicted in FIG. 15 or 16. Then in step S3, the gate switch at the head is selected from the correspondence list 80, for example. An attenuator-on control is performed on that selected gate switch to insert an attenuator in the upstream transmission path to attenuate the upstream signal. For this attenuation of this upstream signal, in the cable router device 18 depicted in FIGS. 1A and 1B, with a decrease in reception level of the upstream signal received through polling by a predetermined level, the cable modem of the transmission source is instructed to amplify the upstream transmission level. Then in step S4, a cable modem in which the transmission level of the upstream signal has been changed with the attenuator-on control over the gate switch is detected by polling all cable modems. Then in step S5, an attenuator-off control is performed on the gate switch subjected to the attenuator-on control in step S3 to separate the attenuator from the upstream transmission path, thereby causing the state back to the original. Then in step S6, a cable modem in which the transmission level of the upstream signal has been back to the original with the attenuator-off control is detected. This cable modem is registered in the correspondence list 80. That is, in the present embodiment, for the cable modem in which the upstream transmission level is changed with the attenuator-on control in step S3 and the upstream transmission level is then back to the original with the attenuator-off control in step S5, a registration indicating of a change in upstream transmission level is performed on the correspondence list 80. Then in step S7, it is checked whether all gate switches have been processed. If not processed, the procedure returns to step S3, thereby repeating similar processes on the next gate switches. When it is determined that all gate switches have been processed, the procedure goes to step S8, where, as for the registered correspondence list 80, the number of cable modems with a level change is calculated for each gate switch for registration. Then in step S9, a parent-child relation of the gate switches is determined from the registered correspondence list 80. In step S10, a gate-switch transmission-path map is generated. This determination of the parent-child relation is performed in a manner such that, after the group transmission-path map 88 of FIG. 17 is formed based on a determination of the gate switch arrangements 84-1 to 84-5 of the cable modem numbers in FIG. 16 as determination targets, a merge process is performed for the same gate switches as in FIG. 18 and, as a result, the gate-switch transmission-path map 88 depicted in FIG. 19 is generated. Then in step S11, transmission-path devices and cable modems are added to the generated gate-switch transmission-path map to complete the transmission-path map. Here, in the transmission-path-map generation process according to the present embodiment, when attenuator-on control and-off control are performed on the gate switches and there is a cable modem that does not respond to polling in an attenuator-control state, such a non-responding cable modem is excluded from the process target for preventing an error in map generation. Furthermore, the present invention provides a program for monitoring upstream ingress noise executed at the fault detection server 10 of FIGS. 1A and 1B. This program includes details depicted in the flowcharts of FIGS. 5 to 9 and 20. Here, in the above embodiment, as a process for searching for an upstream-ingress-noise generation source at the noise-generation-source searching unit 38 in the fault detection server 10 of FIGS. 1A and 1B, the gate switches are controlled from upstream to downstream with the gate-switch management list 54 depicted in FIG. 5, with the optical node being taken as a starting point according to the number of hops, thereby performing division for a noise generation source. Alternatively, irrespectively of the number of hops, the gate switches may be sequentially controlled from upstream to downstream according to a list of the gate switches corresponding to a tree structure of a CATV network prepared in advance to search for an upstream-ingress-noise generation source. Also, in the above embodiment, the case is exemplarily taken in which a cable modem that collects a measurement value for fault monitoring is provided on the CATV transmission path. With a function of returning an operation-complete response being provided to each gate switch, the present embodiment can also be applied as it is to a CATV system without a cable modem. Also, the present invention includes appropriate modifications without impairing its objects and advantages, and further is not restricted by numerical values mentioned in the above embodiment.

What is claimed is:

1. An ingress-noise monitoring system comprising:
a CATV transmission path having a tree structure with an optical node following a headend being taken as a starting point;
a plurality of gate switches placed in a distributed manner on branch lines and a trunk on a subscribers' home side on the CATV transmission path, the gate switches capable of switching an amount of attenuation of an-upstream signal;
an upstream-transmission-quality monitoring unit that monitors an S/N ratio of the upstream signal in a use band obtained from an upstream port having the headend connected thereto to detect a decrease in upstream transmission quality based on a degree of decrease and a continuation state of the S/N ratio; and
a noise-generation-source searching unit that searches for an upstream-ingress-noise generation source by sequentially controlling from upstream to downstream the amount of attenuation of the plurality of gate switches provided on the CATV transmission path when a decrease in upstream transmission quality is detected by the upstream-transmission-quality monitoring unit.

2. The ingress-noise monitoring system according to claim 1, wherein the upstream-transmission-quality monitoring unit holds, for a predetermined decision time, the S/N ratios detected at each predetermined cycles from the upstream signal in the use band obtained from the upstream port, calculates a ratio of the number of detected S/N ratios equal to or smaller than a predetermined S/N threshold with respect to a total number of the detected S/N ratios for the decision time and, when the calculated ratio exceeds a predetermined threshold ratio, detects a decrease in upstream transmission quality.

3. The ingress-noise monitoring system according to claim 1, wherein the transmission-quality monitoring unit
sets a first threshold ratio for alarm notification and a second threshold ratio higher than the first threshold ratio for searching for a noise generation source, each as the threshold ratio, and
when the calculated ratio exceeds the first threshold ratio, provides a notification of an alarm indicative of a decrease in upstream transmission quality, and when the calculated ratio exceeds the second threshold ratio, detects a decrease in upstream transmission quality and causes the noise-generation-source searching unit to operate.

4. The ingress-noise monitoring system according to claim 1, wherein the noise-generation-source searching unit makes an instruction for an attenuator-on control of inserting and connecting an attenuator into an upstream transmission path and, after a predetermined measurement time has elapsed, makes an instruction for an attenuator-off control of removing the attenuator from the upstream transmission path, over the gate switch as a control target, and
when an increase is found in the S/N ratio obtained after the attenuator-on control compared with the S/N ratio before the attenuator-on control and when the SIN ratio obtained after the attenuator-off control is back to the S/N ratio before the attenuator-on control, determines that an upstream-ingress-noise generation source is present under the gate switch as the control target.

5. The ingress-noise monitoring system according to claim 4, wherein, when making an instruction for the attenuator-on control or the attenuator-off control over the gate switch as the control target, after checking a control operation of the gate switch, the noise-generation-source searching unit obtains the S/N ratio of the upstream signal in the use band obtained from the upstream port for determination.

6. The ingress-noise monitoring system according to claim 5, further comprising:
a plurality of cable modems placed in a distributed manner on the branch lines and the trunk on the subscribers' home side placed in the CATV transmission path;
an information collecting unit that collects measurement values detected at the plurality of cable modems through polling; and
a cable router that instructs a cable modem of a transmission source to control an upstream transmission level so that a reception level of the upstream signal received with the polling by the information collecting unit is kept at a constant value, wherein
the noise-generation-source searching unit obtains an upstream transmission level of the cable modem positioned downstream of the gate switch,
makes an instruction for the attenuator-on control and, after a predetermined measurement time has elapsed, makes an instruction for the attenuator-off control over the gate switch as the control target, and
when there is a fluctuation in upstream transmission level equal to or larger than a predetermined value before and after the attenuator-on control and the attenuator-off control, determines that an operation of the gate switch has been completed.

7. The ingress-noise monitoring system according to claim 5, wherein, when making an instruction for the attenuator-on control or the attenuator-off control over the gate switch as the control target, after receiving an operation-complete response signal from the gate switch, the noise-generation-source searching unit obtains the S/N ratio of the upstream signal in the use band obtained from the upstream port for determination.

8. The ingress-noise monitoring system according to claim 4, wherein the noise-generation-source searching unit
manages addresses of the plurality of gate switches with the number of hops as an identifier counted up every time passing through an active device toward a downstream side, with the optical node on the CATV transmission path being taken as a starting point, and
controls the plurality of gate switches according to an order of the number of hops to search for an ingress-noise generation source.

9. The ingress-noise monitoring system according to claim 1, further comprising:
a plurality of cable modems placed in a distributed manner on the branch lines and the trunk on the subscribers' home side placed in the CATV transmission path;
an information collecting unit that collects measurement values detected at the plurality of cable modems through polling;
a cable router that instructs a cable modem of a transmission source to control an upstream transmission level so that a reception level of the upstream signal received with the polling by the information collecting unit is kept at a constant value; and
a transmission-path-map generating unit that sequentially controls all of the gate switches placed at each output port of a plurality of transmission-path devices on the CATV transmission path to change the amount of attenuation of the upstream signal and detects a cable modem in which a transmission level of the upstream signal has been changed with a change in the amount of attenuation to generate a transmission-path map of the transmission-path devices, wherein
the noise-generation-source searching unit searches for an upstream-ingress-noise generation source based on the transmission-path map.

10. The ingress-noise monitoring system according to claim 9, wherein the transmission-path map generating unit includes:
a correspondence-list generating unit that generates the registered correspondence list in which a correspondence relation among one or a plurality of cable modems in which the transmission level of the upstream signal has been changed due to the control over all of the gate switches disposed on the CATV transmission path; and
a parent-child-relation determining unit that determines a parent-child relation of all of the gate switches from the correspondence list to generate a transmission-path map, and
the parent-child-relation determining unit after calculates and registers the number of modems of the cable modems registered for each of the gate switches for the correspondence list and then performs sorting in an order of the number of modems,
generates a gate switch arrangement list having stored therein gate-switch arrangements in which the gate switches are arranged in the order of the number of hops for each cable modem based on the sorted correspondence list,
sequentially takes out a plurality of gate switch arrangements stored in the gate switch arrangement list each as a process target and, when the gate switch arrangement as the process target is included and there is another gate switch arrangement with a same or more number of hops,
deletes the gate switch arrangement as the process target from a parent-child-relation decision target,
merges the same gate switches included in one or a plurality of gate switch arrangements left in the gate switch arrangement list for conversion to a gate-switch transmission-path map having a tree structure, and
adds the transmission-path devices and the cable modems to the gate-switch transmission-path map to complete the transmission-path map.

11. An ingress-noise monitoring method of a CATV system including
a CATV transmission path having a tree structure with an optical node following a headend being taken as a starting point, and
a plurality of gate switches placed in a distributed manner on branch lines and a trunk on a subscribers' home side on the CATV transmission path, the gate switches capable of switching an amount of attenuation of an upstream signal, the method comprising:
an upstream-quality monitoring step of monitoring an S/N ratio of the upstream signal in a use band obtained from an upstream port having the headend connected thereto to detect a decrease in upstream transmission quality based on a degree of decrease and a continuation state of the S/N ratio; and
a noise-source searching step of searching for an upstream-ingress-noise generation source by sequentially controlling from upstream to downstream the amount of attenuation of the gate switches provided on the CATV transmission path when a decrease in upstream transmission quality is detected in the upstream-quality monitoring step.

12. The ingress-noise monitoring method according to claim 11, wherein, in the upstream-transmission-quality monitoring step, S/N ratios detected at each predetermined cycles from the upstream signal in the use band obtained from the upstream port are held for a predetermined decision time, a ratio of the number of detected S/N ratios equal to or smaller than a predetermined S/N threshold with respect to a total number of the detected S/N ratios for the decision time is calculated and, when the calculated ratio exceeds a predetermined threshold ratio, a decrease in upstream transmission quality is detected.

13. The ingress-noise monitoring method according to claim 11, wherein, in the upstream transmission-quality monitoring step,
a first threshold ratio for alarm notification and a second threshold ratio higher than the first threshold ratio for searching for a noise generation source are set, each as the threshold ratio, and
when the calculated ratio exceeds the first threshold ratio, a notification of an alarm indicative of a decrease in upstream transmission quality is provided, and when the calculated ratio exceeds the second threshold ratio, a decrease in upstream transmission quality is detected and the noise-generation-source searching step is caused to operate.

14. The ingress-noise monitoring method according to claim 11, wherein, in the noise-generation-source searching step,
an instruction is made for an attenuator-on control of inserting and connecting an attenuator into an upstream transmission path and, after a predetermined measurement time has elapsed, an instruction is made for an attenuator-off control of removing the attenuator from the upstream transmission path, over a gate switch as a control target, and
when an increase is found in the S/N ratio obtained after the attenuator-on control compared with the S/N ratio before the attenuator-on control and when the S/N ratio obtained after the attenuator-on control is back to the S/N ratio before the attenuator-on control, it is determined that an upstream-ingress-noise generation source is present under the gate switch as the control target.

15. The ingress-noise monitoring method according to claim 14, wherein, in the noise-generation-source searching step, when an instruction for the attenuator-on control or the attenuator-off control over the gate switch as the control target is made, after a control operation of the gate switch is checked, the S/N ratio of the upstream signal in the use band obtained from the upstream port is obtained for determination.

16. The ingress-noise monitoring method according to claim 15, further comprising:
an information collecting step of collecting, through polling, measurement values detected at a plurality of cable modems placed in a distributed manner on the branch lines and the trunk on the subscribers' home side placed in the CATV transmission path; and
an upstream-signal-level controlling step of instructing a cable modem of a transmission source to control an upstream transmission level so that the received upstream signal at a cable router with the polling in the information collecting step is kept at a constant value, wherein
in the noise-generation-source searching step, an upstream transmission level of the cable modem positioned downstream of the gate switch is obtained,
an instruction is made for the attenuator-on control and, after a predetermined measurement time has elapsed, an instruction is made for the attenuator-off control over the gate switch as the control target, and
when there is a fluctuation in upstream transmission level equal to or larger than a predetermined value before and after the attenuator-on control and the attenuator-off control, it is determined that an operation of the gate switch has been completed.

17. The ingress-noise monitoring method according to claim 15, wherein, in the noise-generation-source searching step, when an instruction is made for the attenuator-on control or the attenuator-off control over the gate switch as the control target, after an operation-complete response signal is received from the gate switch, the S/N ratio of the upstream signal in the use band obtained from the upstream port is obtained for determination.

18. The ingress-noise monitoring method according to claim 13, wherein, in the noise-generation-source searching step,
addresses of the plurality of gate switches are managed with the number of hops as an identifier counted up every time passing through an active device toward downstream side, with the optical node on the CATV transmission path being taken as a starting point, and
the plurality of gate switches are controlled according to an order of the number of hops to search for an ingress-noise generation source.

19. The ingress-noise monitoring method according to claim 11 further comprising:
an information collecting step of collecting, through polling, measurement values detected at the plurality of cable modems placed in a distributed manner on the branch lines and the trunk on the subscribers' home side placed in the CATV transmission path;
an upstream-signal-level control step of instructing a cable modem of a transmission source to control an upstream transmission level so that a reception level of the upstream signal received by a cable router with the poling in the information collecting step is kept at a constant value; and
a transmission-path-map generating step of sequentially controlling all of the gate switches placed at each output port of a plurality of transmission-path devices on the CATV transmission path to change the amount of attenuation of the upstream signal and detecting a cable modem in which a transmission level of the upstream signal has been changed with a change in the amount of attenuation to generate a transmission-path map of the transmission-path devices, wherein
in the noise-generation-source searching step, an upstream-ingress-noise generation source is searched for based on the transmission-path map.

20. The ingress-noise monitoring method according to claim 19, wherein the transmission-path map generating step includes:
a correspondence-list generating step of generating the registered correspondence list in which a correspondence relation among one or a plurality of cable modems in which the transmission level of the upstream signal has been changed due to the control over all of the gate switches disposed on the CATV transmission path; and
a parent-child-relation determining step of determining a parent-child relation of all of the gate switches from the correspondence list to generate a transmission-path map, and
in the parent-child-relation determining step, the number of modems of the cable modems registered for each of the gate switches is calculated and registered for the correspondence list and then sorting is performed in an order of the number of modems,
a gate switch arrangement list having stored therein gate-switch arrangements in which the gate switches are arranged in the order of the number of hops for each cable modem is generated based on the sorted correspondence list,
a plurality of gate switch arrangements stored in the gate switch arrangement list are sequentially taken out each as a process target and, when the gate switch arrangement as the process target is included and there is another gate switch arrangement with a same or more number of hops, the gate switch arrangement as the process target is deleted from a parent-child-relation decision target,
same gate switches included in one or a plurality of gate switch arrangements left in the gate switch arrangement list are merged for conversion to a gate-switch transmission-path map having a tree structure, and the transmission-path devices and the cable modems are added to the gate-switch transmission-path map to complete the transmission-path map.
